(19) United States
(12) Patent Application Publication
(10) Pub. No.: US 2020/0227725 A1
(43) Pub. Date: Jul. 16, 2020

(54) LITHIUM SULFUR BATTERIES AND COMPONENTS THEREOF

(71) Applicant: Cornell University, Ithaca, NY (US)

(72) Inventors: Yong Lak JOO, Ithaca, NY (US); Brian P. WILLIAMS, Ithaca, NY (US)

(21) Appl. No.: 16/632,173

(22) PCT Filed: Jul. 19, 2018
(86) PCT No.: PCT/US2018/042878

§ 371 Date: Jan. 17, 2020

Related U.S. Application Data
(60) Provisional application No. 62/534,419, filed on Jul. 19, 2017.

(51) Int. Cl. H01M 4/136; H01M 4/131; H01M 4/66; H01M 10/052; H01M 10/0565; H01M 2/16

(52) U.S. Cl. CPC H01M 4/136; H01M 4/131; H01M 4/663; H01M 2004/021; H01M 10/0565; H01M 2/1673; H01M 10/052

(57) ABSTRACT

Provided herein are positive electrode systems for lithium batteries, particularly lithium sulfur batteries, component parts thereof, and the manufacture thereof. Specifically provided herein are lithium sulfur battery cathode systems comprising mesoporous carbon components, including sulfur loaded substrates and sulfur-free interlayers, such as comprising mesoporous carbon component(s), grapheme component(s), polymer or binder component(s), conducting additive component(s), and/or ionic shielding component(s).

### CROSS-REFERENCE

This application claims the benefit of U.S. Provisional Application No. 62/534,419 filed 19 Jul. 2017, which is incorporated herein by reference in its entirety.

### FIELD OF THE INVENTION

The field relates to lithium (sulfur) batteries, including positive electrode systems therefor, particularly sulfur electrode systems, component parts thereof, and the manufacture thereof. In some instances, the field relates to battery separator materials and mesoporous carbon materials, as well as methods of manufacturing the same.

### BACKGROUND OF THE INVENTION

Batteries comprise one or more electrochemical cell, such cells generally comprising a cathode, an anode and an electrolyte. Lithium secondary batteries are high energy density batteries that are fairly commonly used in consumer electronics and electric vehicles. In lithium secondary batteries, lithium ions generally move from the negative electrode to the positive electrode during discharge and vice versa when charging. The rechargeable battery industry has seen a rapid growth in recent years. Applications vary widely, and include large-scale banks of batteries for grid storage of intermittent renewable energy sources, as well as small-scale cells for wearable electronic devices. Despite the slow improvement in their performance, Li-ion batteries are still expected to apply to large size applications such as electric vehicles (EVs) and energy storage system (ESS).

### SUMMARY OF THE INVENTION

To achieve further expansion of Li-ion batteries into various applications including EVs and ESS, their performance in terms of energy density and power density, rate capability, cycle-ability, and safety should be improved significantly. However, the progress of improving the energy density of Li-ion batteries has been impeded by the limited capacities (e.g., <240 mAhg⁻¹) of cathode materials based on Li metal oxides (e.g., LiCoO₂, LiNi₁₋ₓMₓO₂, LiNiₓMn_{y}Co₂O₂). To overcome the limited capacities of conventional lithium-intercalation metal oxide cathode materials, new cathode materials based on sulfur embedment are introduced. The sulfur cathode has an astounding theoretical capacity of 1,675 mAh/g. In addition, sulfur is an inexpensive earth-abundant material, which makes it an even more attractive candidate as a cathode material. In certain embodiments provided herein are high capacity lithium secondary batteries with good cycling capabilities.

In certain embodiments, provided herein are batteries (e.g., lithium sulfur batteries), components thereof, and processes for making the same. In some embodiments, provided herein are bodies or materials (e.g., referred to herein as interlayers) configured between an electrode material (e.g., a cathode or positive electrode material comprising a substrate component (e.g., a porous carbon material described herein) and a sulfur component (e.g., elemental sulfur and/or sulfides), such as wherein the substrate component is infused with the sulfur component) and a separator. In certain instances, such interlayers function to improve capacity retention and/or reduce shuttling of active or sulfur materials (e.g., electrolyte soluble sulfide materials) away from an electrode (e.g., lithium sulfur cathode).

In certain instances, a lithium sulfur battery provided herein comprises a positive electrode (cathode), negative electrode (anode) and a separator. In some instances, the battery operates by transport of lithium ions from the negative electrode to the positive electrode and vice versa. In some embodiments, a positive electrode generally comprises a sulfur component. The negative electrode comprises any suitable material, such as lithium metal, silicon, lithiated silicon, lithiated carbon (e.g., graphite), or the like. Due to their low cost and high energy capacity (e.g., up to 2-3 times or more greater than the best lithium ion battery alternatives), lithium sulfur (Li—S) batteries may become the preferred power source for many industrial and commercial applications, such as in electric vehicles. Mass adoption and commercialization of lithium sulfur batteries have been impossible, however, for a number of reasons, including poor capacities (e.g., due to low cathode loading of sulfur), a short life cycle, and poor rate capabilities. In some instances, these difficulties stem from the ability of polysulfides to dissolve into the electrolyte at the sulfur cathode, migrate across the separator, react with and/or create an insulating layer on the anode. In some instances, configurations and materials provided herein (e.g., use of an interlayer components herein) address these problems, and/or facilitate improved energy density, life cycle, and/or rate capabilities of battery chemistries, such as lithium sulfur battery chemistries.

In some embodiments, provided herein is an interlayer, an electrode (e.g., cathode) system comprising an interlayer, or a battery (e.g., lithium battery) comprising an interlayer. In certain embodiments, the interlayer is a porous (e.g., mesoporous) film. In certain embodiments, the interlayer comprises a porous material (e.g., a mesoporous material, such as a mesoporous carbonaceous material). In some embodiments, the interlayer comprises at least one carbonaceous material. In more specific embodiments, the interlayer comprises mesoporous carbon, a graphenic component (e.g., graphene, reduced graphene oxide, graphene oxide, functionalized graphene, or the like), or a combination thereof. In certain embodiments, an interlayer provided herein comprises a first part or layer comprising mesoporous carbon and a second part or layer comprising a graphenic component.

In certain embodiments, an interlayer comprises one or more porous material, such as a mesoporous carbon component. In various embodiments, the interlayer comprises mesoporous carbon nanofibers (e.g., having an aspect ratio of at least 10, at least 20, at least 50, at least 100, or the like), mesoporous carbon powder (particles) (e.g., having an aspect ratio of less than 10, less than 5, or the like), or a combination thereof. In specific embodiments, the interlayer comprises mesoporous carbon nanofibers and mesoporous carbon powder. In some instances, combining nanofiber and particle/powder structures facilitates good packing of the material and improved surface area/mesopore concentration in the interlayer, which, in some instances, facilitates retention of the sulfur and sulfide material at the cathode.

In some embodiments, the mesoporous carbon (nanofibers and/or powder) has an average and/or peak mesoporous pore size (e.g., based on number of pores or the peak or maximum incremental mesopore (e.g., having a size of 2 nm to 100 nm, 2 nm to 50 nm, or the like) area—the pore area contributed by pores of a particular size) (and/or volume) of at least 5 nm, such as at least 10 nm, at least 15 nm, at least 20 nm, at least 25 nm, or at least 50 nm (e.g., up to 25 nm, up to 50 nm, or up to 100 nm) (e.g., based on the maximum dimension of the pore). In certain instances, slightly increased pore size (without going beyond the mesoporous size) facilitates ingress and egress of lithium ions into the mesopores (without becoming trapped), while also maintaining high surface area of the material.

In specific embodiments, an interlayer provided herein comprises a graphenic component. In various embodiments, any suitable graphenic component (e.g., graphene, graphene oxide or reduced graphene oxide) is utilized, such as comprising carbon, hydrogen, and oxygen. Specific characteristics of such graphenic components are described in more detail in the detailed description herein. In specific embodiments, a graphenic component provided herein is functionalized with an ionic shielding group (e.g., a polar or charged group that functions to repel sulfide groups). In more specific embodiments, a graphenic component provided herein comprises or is functionalized with a sulfoxide (—SOR), sulfone (—SO₂R), sulfonate (—SO₃R) group (e.g., wherein each R is independently absent (a negative charge), H, alkyl, heteroalkyl, aryl, heteroaryl, or the like). In certain embodiments, ionic shielding group is attached directly to a graphenic lattice, or via a linking group, such as a group comprising alkyl, heteroalkyl, aryl, heteroaryl, and/or the like. In specific embodiments, the graphenic component comprises one or more sulfonate (—SO₃R) group, such as one or more -alkyl-SO₃R group and/or one or more -aryl-SO₃R group (e.g., -phenyl-SO₃R group).

In certain embodiments, a battery (e.g., lithium battery) or a separator comprises an interlayer provided herein. In some embodiments, a battery provided herein comprises a first electrode (e.g., cathode, such as a carbon-sulfur cathode), a second electrode (e.g., anode, such as comprising lithium metal and/or lithiated silicon), a separator and an interlayer. In some embodiments, the interlayer is configured between the first electrode and the separator and/or the separator is positioned between the interlayer and the second electrode.

In some instances, a separator and an interlayer provided herein are discrete elements of a battery. In other instances, a separator and an interlayer provided herein are integrated, such as forming a film laminate (e.g., wherein the separator and interlayer are fixed together) or a coated separator. In still other embodiments, part of an interlayer provided herein is discrete from the separator and another part of the laminate is part of the separator. In certain embodiments, the interlayer is integrated with the first electrode (e.g., cathode). In some embodiments, the interlayer is discrete from the separator and/or first electrode.

In certain embodiments, the porous material of an interlayer comprises a nanofiber mat, such as a porous carbon nanofiber mat. In some instances, the nanofiber mat is a membrane, such as self-supporting membrane. In certain embodiments, the nanofiber mat forms a discrete membrane configured between a first electrode and separator provided herein. In some instances, nanofiber materials are utilized in an interlayer provided herein without being in the form of a mat. In certain embodiments, nanofibers are optionally broken into smaller segments and formed into a film or layer that is discrete from the first electrode and/or separator or forms a laminate with the first electrode and/or separator. In certain embodiments, a mesoporous material (e.g., mesoporous carbon nanofibers and/or mesoporous carbon particles) are electrosprayed onto a surface of a separator provided herein (e.g., according to a gas-controlled electrospray process described herein), such as to provide a separator-interlayer laminate.

In some embodiments, provided herein is a battery (e.g., lithium-sulfur battery) comprising a first electrode, a second electrode and a separator. In specific embodiments, the battery (optionally) comprises an interlayer, such as described herein. In some embodiments, the first electrode of a battery provided herein is a lithium sulfur cathode. In specific embodiments, the first electrode comprises a porous and/or conductive component or substrate and a sulfur component. In certain embodiments, the porous and/or conductive component is a carbonaceous component, such as a porous carbon substrate, e.g., mesoporous carbon, carbon paper, or the like. In some embodiments, the substrate is a porous (e.g., mesoporous) carbon substrate, such as comprising (e.g., mesoporous) carbon nanofibers (e.g., a mat thereof), (e.g., mesoporous) carbon powder, (e.g., mesoporous) carbon paper, and/or the like. In some embodiments, the electrode comprises one or more porous material or substrate, such as a mesoporous carbon component. In various embodiments, the electrode comprises mesoporous carbon nanofibers (e.g., having an aspect ratio of at least 10, at least 20, at least 50, at least 100, or the like), mesoporous carbon powder (particles) (e.g., having an aspect ratio of less than 10, less than 5, or the like), or a combination thereof. In specific embodiments, the electrode comprises mesoporous carbon nanofibers and mesoporous carbon powder. In some instances, combining nanofiber and particle/powder structures facilitates good packing of the material and improved surface area/mesopore concentration in the electrode, which, in some instances, facilitates retention of the sulfur and sulfide material at the cathode. In some embodiments, the mesoporous carbon (nanofibers and/or powder) has an average and/or (e.g., number) peak mesoporous pore size of at least 5 nm, such as at least 10 nm, at least 15 nm, at least 20 nm, at least 25 nm, or at least 50 nm (e.g., up to 25 nm, up to 50 nm, or up to 100 nm) (e.g., based on the maximum dimension of the pore). In certain embodiments, the mesopore size (e.g., of the pores having a size between 2 nm and 50 nm, or 2 nm and 100 nm) of the mesoporous carbon (nanofibers and/or powder) contributing the greatest area to the mesoporous carbon is at least 5 nm, such as at least 10 nm, at least 15 nm, at least 20 nm, at least 25 nm, or at least 50 nm (e.g., up to 25 nm, up to 50 nm, or up to 100 nm) (e.g., based on the maximum dimension of the pore). In some embodiments, the maximum incremental mesopore area (e.g., the collective area of all of the mesopores of the mesoporous carbon having a particular pore size) (and/or volume) of the mesoporous carbon is achieved for mesopores (e.g., of the pores having a size between 2 nm and 50 nm, 3 nm and 50 nm, or 2 nm and 100 nm) having mesopore size of at least 5 nm, such as at least 10 nm, at least 15 nm, at least 20 nm, at least 25 nm, or at least 50 nm (e.g., up to 25 nm, up to 50 nm, or up to 100 nm) (e.g., based on the maximum dimension of the pore). In certain instances, slightly increased pore size (without going beyond the mesoporous size) facilitates ingress and egress of lithium ions into the mesopores (without becoming trapped), while also maintaining high surface area and porosity of the material.

As discussed herein, in certain embodiments, the substrate or carbonaceous component of an electrode and/or the interlayer comprises a porous material. In specific embodiments, a porous material of the electrode (e.g., substrate thereof) and/or interlayer has a surface are of about 400 m²/g or more. In more specific embodiments, a porous material of the electrode and/or interlayer has a surface are of about 500 m²/g or more. In still more specific embodiments, a porous material of the electrode and/or interlayer has a surface are of about 650 m²/g or more.

In some embodiments, porous material (e.g., mesoporous carbon) provided in electrodes and/or interlayers provided herein have a high degree of mesoporosity (e.g., relative to microporosity). In certain embodiments, porous material (e.g., mesoporous carbon) provided in electrodes and/or interlayers provided herein comprise both mesoporous (e.g., pores 2-100 nm in diameter) and microporous elements (e.g., pores less than 2 nm in diameter). In certain embodiments, the micropore fraction of the surface area is less than 90%, less than 85%, less than 80%, less than 75%, less than 70% of the surface area of the material. In some embodiments, however, microporous domains are also desired (e.g., to provide good capacity values), particularly in the electrode porous materials. In specific embodiments, the micropore fraction of the surface area is at least 2%, at least 10%, at least 20%, at least 30, or the like of the surface area of the material.

In certain embodiments, a porous carbon material (e.g., mesoporous carbon) provided in electrodes and/or interlayers herein comprise activated carbon (e.g., activated to produce micropores on the surface thereof and/or increase the surface area thereof). In certain embodiments, the carbon is activated under any suitable conditions, such as at about 400° C. to about 700° C., such as with air, KOH or carbon dioxide.

In certain embodiments, an electrode (e.g., lithium sulfur cathode) and/or interlayer further comprises a carbon and/or conducting additive, such as a graphitic component (e.g., graphite), a graphenic component (e.g., graphene, reduced graphene oxide (rGO), graphene oxide (GO), graphene nanoribbons, or a combination thereof), carbon nanotubes, carbon black, any combination of two or more thereof, or the like. In some embodiments, an electrode and/or interlayer comprises a first domain and a second domain, such as wherein the first domain comprises a porous carbon substrate (e.g., and a conducting and/or carbonaceous additive) (e.g., with a sulfur component loaded therein in the electrode material) and the second domain comprises a conducting and/or carbonaceous additive on the surface of the porous material (e.g., in the electrode on the surface proximal to an interlayer or separator, such as being configured between the electrode (e.g., cathode) substrate and the interlayer or separator). In some instances, the second domain can be continuous or discontinuous, and in some instances, forms a porous film or deposition.

In preferred embodiments, an electrode (e.g., first electrode or lithium sulfur cathode) provided herein comprises mesoporous carbon (e.g., having large mesoporous structures, such as described herein), a graphenic component, and a sulfur component. In specific embodiments, the electrode comprises mesoporous carbon nanofibers (e.g., having large mesoporous structures, such as described herein), mesoporous carbon powder, a graphenic component, and a sulfur component.

In certain embodiments, an electrode (e.g., lithium sulfur cathode) (or substrate thereof) and/or interlayer provided herein comprises (e.g., mesoporous) carbon nanofibers. In some embodiments, the nanofibers have an average diameter of about 2 nm or more (e.g., about 2 nm to about 5,000 nm (5 micron)). In specific embodiments, the nanofibers have a diameter of about 50 nm or more (e.g., about 50 nm to about 2 micron). In still more specific embodiments, the nanofibers have an average diameter of about 100 nm or more, about 200 nm or more, or the like (e.g., up to about 2 micron).

An interlayer and/or electrode provided herein has any suitable thickness. In preferred embodiments, the mass and thickness of the interlayer is as small as possible in order to provide maximum gravimetric and volumetric energy density of a battery comprising the interlayer. In certain embodiments, the mass and/or thickness of the interlayer is less than 200% that of the first electrode. In more preferred embodiments, the mass and/or thickness of the interlayer is less than 100% that of the first electrode. In specific embodiments, the mass and/or thickness of the interlayer is less than 50% that of the first electrode. In more specific embodiments, the mass and/or thickness of the interlayer is less than 30% that of the first electrode. In still more specific embodiments, the mass and/or thickness of the interlayer is about ¼ that of the first electrode. In some embodiments, the mass and/or thickness of the interlayer is at least 2% (e.g., at least 5%, at least 10%, at least 20%, at least 50%, at least 100%, or the like) that of the first electrode.

In certain instances, the morphology (e.g., pore size distribution and size, as well as surface area and additives) of the interlayer and/or electrode described herein facilitates good performance of batteries (e.g., lithium sulfur batteries) comprising such material(s). In particular, in some instances, these morphologies facilitate the high loading of sulfur component into the cathode material, which allows for very good battery capacities, while also providing good capacity retention and rate (e.g., charge) capabilities.

In some embodiments, an electrode provided herein has a loading of at least 2 mg sulfur component per cm² of electrode. In more preferred embodiments, the electrode has a sulfur component loading of at least 3 mg/cm². In specific embodiments, the electrode has a sulfur component loading of at least 4 mg/cm². In more specific embodiments, the electrode has a sulfur component loading of at least 5 mg/cm². In still more specific embodiments, the electrode has a sulfur component loading of about 5 to about 10 mg/cm². In some embodiments, the electrode has a sulfur component loading of at least 6 mg/cm².

In various embodiments, any suitable sulfur component is utilized. In specific embodiments, the sulfur component is sulfur, a sulfide, a polysulfide, an organosulfide, or any combination thereof. In many lithium sulfur battery applications, (elemental) sulfur is not a preferred sulfur component because of its poor conductivity, the solubility of polysulfides derived therefrom during battery operation, poor loading capabilities, and the like. To overcome such deficiencies, sulfides, polysulfides, and organosulfides are often utilized, but are not always practical because of the high costs thereof—particularly relative to the inexpensive sulfur. In certain embodiments herein, high loading of sulfur with good battery performance characteristics is achieved using sulfur (e.g., due to the morphology of the cathode, interlayer and/or ionic shield structures described herein). In some preferred embodiments herein, the sulfur component is or comprises sulfur (e.g., elemental sulfur).

In certain embodiments, an electrode (e.g., lithium sulfur cathode) and/or interlayer provided herein comprises the same or different components. In some general pre-operational embodiments, the electrode comprises a sulfur component and the interlayer does not. During operation, however, dissolution of polysulfides at the cathode can cause migration of the sulfur component into the interlayer structure. In certain instances, the interlayer functions as a trapping layer designed to capture soluble polysulfides and, in some instances, release back to the cathode during battery operation. In some instances, a battery provided herein comprises an ionic shield (e.g., comprising a layer of functionalized graphenic component, such as described herein), such as part of the interlayer or as part of a separator, to serve as another or final barrier to prevent or retard shuttling of sulfur components to the other battery electrode (lithium sulfur anode).

In some embodiments, an electrode (e.g., lithium sulfur cathode) of a battery provided herein comprises at least 2 times the amount of sulfur component (e.g., sulfur) as does the interlayer. In specific embodiments, an electrode (e.g., lithium sulfur cathode) of a battery provided herein comprises at least 3 times the amount of sulfur component (e.g., sulfur) as does the interlayer. In more specific embodiments, an electrode (e.g., lithium sulfur cathode) of a battery provided herein comprises at least 5 times the amount of sulfur component (e.g., sulfur) as does the interlayer. In still more specific embodiments, an electrode (e.g., lithium sulfur cathode) of a battery provided herein comprises at least 10 times the amount of sulfur component (e.g., sulfur) as does the interlayer. In yet more specific embodiments, an electrode (e.g., lithium sulfur cathode) of a battery provided herein comprises at least 20 times the amount of sulfur component (e.g., sulfur) as does the interlayer.

In certain embodiments, use of an interlayer described herein significantly improves performance of a battery. In some instances, capacity is improved, rate capability is improved, capacity retention is improved, and/or the like. In certain embodiments, the capacity of an electrode provided herein with an interlayer is at least 150% of an electrode without an interlayer (e.g., when holding mass of interlayer+electrode substrate equivalent to electrode substrate without an interlayer, and/or holding the amount of sulfur component constant). In specific embodiments, the capacity of an electrode provided herein with an interlayer is at least 200% of an electrode without an interlayer (e.g., when holding mass of interlayer+electrode substrate equivalent to electrode substrate without an interlayer, and/or holding the amount of sulfur component constant). In more specific embodiments, the capacity of an electrode provided herein with an interlayer is at least 250% of an electrode without an interlayer (e.g., when holding mass of interlayer+electrode substrate equivalent to electrode substrate without an interlayer, and/or holding the amount of sulfur component constant). In various embodiments, such capacities refer to initial capacity, capacity after 50 cycles, capacity after 100 cycles, capacity after 200 cycles, capacity after 300 cycles, and/or the like.

In some embodiments, batteries (e.g., lithium sulfur batteries) or components thereof have very good performance characteristics. In some instances, an electrode (e.g., lithium sulfur cathode) provided herein has a (e.g., initial, or after 10 cycles) capacity of at least 600 mAh/g_{sulfur}. In specific embodiments, an electrode (e.g., lithium sulfur cathode) provided herein has a (e.g., initial, or after 10 cycles) capacity of at least 700 mAh/g_{sulfur}. In more specific embodiments, an electrode (e.g., lithium sulfur cathode) provided herein has a (e.g., initial, or after 10 cycles) capacity of at least 800 mAh/g_{sulfur}. In still more specific embodiments, an electrode (e.g., lithium sulfur cathode) provided herein has a (e.g., initial, or after 10 cycles) capacity of at least 900 mAh/g_{sulfur}. In yet more specific embodiments, an electrode (e.g., lithium sulfur cathode) provided herein has a (e.g., initial, or after 10 cycles) capacity of at least 1,000 mAh/g_{sulfur}. In various embodiments, such capacities are achieved even at very high loading of sulfur component in the electrode, such as at least 3 mg/cm², at least 4 mg/cm², at least 5 mg/cm², at least 6 mg/cm², about 5 to about 10 mg/cm², at least 3 mg/cm³, at least 4 mg/cm³, at least 5 mg/cm³, or the like. Further, in some instances, good capacities, such as discussed herein are achieved at a variety of charge rates, including at very high charge rates. In some embodiments, such capacities are achieved at a rate of about 0.5 C or more (wherein 1 C is the rate at which it takes to completely charge the electrode in 1 hour), about 1 C or more, about 2 C or more, about 3 C or more, about 4 C or more, or even higher. In other words, in some instances, electrode systems (e.g., comprising electrode, and interlayer and/or ionic shield) provided herein have capacities that are 2-3 times the capacities of conventional lithium ion battery cathodes while having an ability to be complete charged in less than 30 minutes, or even less. In certain embodiments, such capacities provided are initial capacities, capacities after 10 cycles, capacities after 50 cycles, capacities after 100 cycles, or a combination thereof.

In some embodiments, the capacity of the electrode system is at least 600 mAh/g_{sulfur} (e.g., at least 700 mAh/g_{sulfur}, or at least 800 mAh/g_{sulfur}) at a charge and/or discharge rate of 3 C. In certain embodiments, the capacity of the electrode system is at least 700 mAh/g_{sulfur} (e.g., at least 800 mAh/g_{sulfur}, or at least 900 mAh/g_{sulfur}) at a charge and/or discharge rate of 2 C. In some embodiments, the capacity of the electrode system is at least 800 mAh/g_{sulfur} (e.g., at least 900 mAh/g_{sulfur}, or at least 1,000 mAh/g_{sulfur}) at a charge and/or discharge rate of 1 C. In some embodiments, the capacity of the electrode system is at least 900 mAh/g_{sulfur} (e.g., at least 1,000 mAh/g_{sulfur}, or at least 1,100 mAh/g_{sulfur}) at a charge and/or discharge rate of 1 C. Moreover, in specific embodiments, such a high capacity at a high rate is achieved with a high sulfur loading, such as at least 3 mg/cm², at least 4 mg/cm², at least 5 mg/cm², at least 3 mg/cm³, at least 4 mg/cm³, at least 5 mg/cm³, or the like.

In general, unless otherwise stated, any capacity described herein refers to the capacity based on the weight of a cathode, cathode system, or sulfur described herein. In specific instances, the capacity refers to the capacity based on the weight of sulfur.

In specific embodiments, provided herein is a lithium sulfur battery comprising a cathode, an anode, an interlayer, and a separator, the interlayer configured between the cathode and the separator, and the separator configured between the interlayer and the anode. In some embodiments, the cathode comprises a mesoporous carbon (e.g., nanofiber and/or particle) infused with a sulfur component (e.g., sulfur). In specific embodiments, the loading of the sulfur component (e.g., sulfur) in the cathode is at least 5 mg/cm².

In certain embodiments, the areal capacity of the cathode is at least 4 mAh/cm². In specific embodiments, the areal capacity is at least 5 mAh/cm². In more specific embodiments, the areal capacity is at least 6 mAh/cm².

In some embodiments, the separator and interlayer are optionally integrated or discrete. In specific embodiments, the interlayer and separator is a laminate, and the interlayer comprises mesoporous carbon (e.g., nanofiber and/or particles) (e.g., a separator coated with mesoporous carbon (e.g., nanofibers)). In specific embodiments, the interlayer thickness is about 20 micron or less, and the separator or separator/interlayer laminate has an ionic conductivity of at least 1.5 mS/cm. Any suitable anode is optionally used. In specific embodiments, the anode is a lithium metal anode.

In some embodiments, a cathode, cathode system, or lithium sulfur battery provided has very good capacity retention, such as about 80% or more after 100 cycles, about 85% or more after 100 cycles, about 90% or more after 100 cycles, about 95% or more after 100 cycles, or the like. In certain embodiments, a cathode, cathode system, or lithium sulfur battery provided has a capacity retention of about 80% or more after 200 cycles, about 85% or more after 200 cycles, or about 90% or more after 200 cycles.

In certain embodiments, a lithium sulfur battery provided herein has a capacity of at least 300 Wh/kg, at least 400 Wh/kg, at least 500 Wh/kg, or more.

Capacity and capacity retention values provided herein are achieved at any suitable rate (unless specifically stated otherwise), such as at a rate of at least C/2, at least 1 C, at least 2 C, or the like.

In certain embodiments, a lithium sulfur battery provided herein has a capacity of at least 500 Wh/kg (e.g., at a charge rate of 0.5 C), and/or a capacity retention of at least 80% after 300 cycles.

In some instances, for carbon interlayers in Li—S batteries to be effective in highly loaded, larger scale batteries, the interlayer operates like a filter which can trap slowly diffusing polysulfides on their way to the lithium anode. If all the sulfur quickly relocates and evenly distributes itself between the cathode and the interlayer during cycling, then the interlayer effectively acts as a mere extension of the cathode and could be improving performance only by lowering the overall loading of sulfur in the cathode, which is not scalable. In some embodiments, reduction of the interlayer mass without sacrificing the cell performance is achieved by introducing either more compact assembly of mesoporous carbon or additional ionic shielding component (e.g., with GO, or otherwise functionalized graphene, rGO, GO, or the like) between the electrode substrate and the separator, such as by coating the ionic shielding component (e.g., concurrently or sequentially with coating of a mesoporous carbon component) directly on the separator (e.g., via a gas assisted electrospray process, such as described herein).

Also provided herein are processes of manufacturing (e.g., by electrospinning techniques described herein, such as gas-assisted electrospinning) mesoporous nanofibers and/or electrode system and/or interlayer materials comprising mesoporous nanofibers. In specific embodiments, such a process comprises:
a. mixing a first polymer with a second polymer, forming a liquid polymer mixture (e.g., neat or in solution);
b. applying a voltage or an electrical charge to the liquid polymer mixture (e.g., forming a charged liquid polymer mixture);
c. injecting the charged liquid polymer mixture into a stream of gas; and
d. thermally treating one or more resultant nanofiber (e.g., carbonizing the first polymer and removing the second polymer), forming one or more mesoporous carbon nanofiber.

In certain embodiments, the second polymer is a sacrificial polymer, which is removed upon thermal treatment (e.g., less than 20 wt. % remains (e.g., as carbon), less than 10 wt. % remains, less than 5 wt. % remains after thermal treatment). In some embodiments, the first polymer is a polymer that is carbonized after thermal treatment (e.g., at least 20 wt. % remains (e.g., as carbon), at least 30 wt. % remains, at least 40 wt. % remains, at least 50 wt. % remains, or the like after thermal treatment.

In specific embodiments, the first and second polymers are not miscible with one another, such as forming separate domains during processing (e.g., electrospinning). In some embodiments, the second polymer forms discrete domains within a matrix of the first domain during processing (e.g., electrospinning, such as gas-assisted electrospinning).

In some embodiments, the first polymer is polyacrylonitrile (PAN), polyvinylacetate (PVA), polyvinylpyrrolidone (PVP), a cellulose (e.g., cellulose), a polyalkylene (e.g., ultra-high molecular weight polyethylene (UHMWPE)), or the like. In certain embodiments, the first polymer is styrene-co-acrylonitrile (SAN), or m-aramid. In certain embodiments, the second (e.g., sacrificial) polymer is a polyalkyleneoxide (e.g., PEO), polyvinylacetate (PVA), a cellulose (e.g., cellulose acetate, cellulose diacetate, cellulose triacetate, cellulose), nafion, polyvinylpyrrolidone (PVP), acrylonitrile butadiene styrene (ABS), polycarbonate, a polyacrylate or polyalkylalkacrylate (e.g., polymethylmethacrylate (PMMA)), polyethylene terephthalate (PET), nylon, polyphenylene sulfide (PPS), or the like. In some embodiments, the second polymer is styrene-co-acrylonitrile (SAN), polystyrene, a polymimide or an aramid (e.g., m-aramid). In specific embodiments, the second polymer is a cellulose, a polyimide or an aramid. Generally, the first and second polymers are different. In preferred embodiments, the first polymer is polyacrylonitrile (PAN) and the second polymer is cellulose diacetate (CDA) and/or polymethymethacrylate (PMMA). However, any suitable polymers are optionally utilized, such as described in WO 2015/027052, entitled “Porous Carbon Nanofibers and Manufacturing Thereof,” which is incorporated herein by reference in its entirety.

In specific embodiments, the first polymer and second polymer are mixed with a solvent to form the liquid polymer mixture, such as a polymer solution. Any suitable concentration is optionally utilized. In gas-assisted processes provided herein, high loading of polymer in the solution is possible, with liquid polymer mixture viscosities of at least 50 cP, at least 100 cP, at least 250 cP, at least 500 cP, at least 1,000 cP, or more being utilized.

In some embodiments, the liquid polymer mixture is injected (or otherwise ejected, such as from an electrospin nozzle) with and/or into one or more gas stream at a direction that is within about 15 degrees of the direction of the one or more gas stream. In specific embodiments, the liquid polymer mixture is injected into or ejected with one or more gas stream at a direction that is within about 10 degrees of the direction of the one or more gas stream. In more specific embodiments, the liquid polymer mixture is injected into or ejected with one or more gas stream at a direction that is within about 5 degrees of the direction of the one or more gas stream.

In certain embodiments, humidity control of the atmosphere into which the polymer mixture is injected facilitates control of the mesopore size distributions of the mesoporous carbon nanofibers described herein. For example, as illustrated in the examples and figures herein, in some instances, lower relative humidity produce smaller pore sizes, whereas large relative humidity produce larger pore sizes. As discussed herein, in some instances, larger mesopore sizes facilitate improved performance parameters, such as when used in a cathode substrate material herein. In some embodiments, the relative humidity (RH) of a gas stream and/or ambient atmosphere into which a polymer mixture is injected is about 10% or more. In specific embodiments, the relative humidity is about 30% or more, such as about 30% to about 50%. In more specific embodiments, the relative humidity is about 50% or more. In specific embodiments, the relative humidity (RH) of the ambient conditions into which the fibers are injected or electrospun are controlled to provide a relative humidity, such as described herein.

In certain embodiments, a process herein further comprises activating the mesoporous carbon provided herein, such as by a thermal treatment described herein.

In certain embodiments, wherein an interlayer is prepared, the process further comprises assembling the one or more mesoporous carbon nanofiber into a battery interlayer. In some embodiments, the collected mesoporous carbon nanofiber is collected as a nanofiber mat and assembled into an interlayer material, such as by cropping and/or compressing the mat. In certain embodiments, additional components are deposited on the nanofiber mat, such as by electrospray techniques, including gas-assisted electrospray techniques described herein. In certain embodiments, collected mesoporous carbon nanofibers are collected and deposited (e.g., by electrospray (e.g., using a gas-assisted electrospray technique described herein)) onto an electrode and/or separator described herein. In some embodiments, the collected mesoporous carbon nanofibers are chopped or otherwise broken up prior to processing. In some embodiments, the mesoporous carbon nanofibers are deposited concurrently or sequentially with mesoporous carbon powder and/or a graphenic component.

In some embodiments, provided herein is a method of preparing an electrode, or battery comprising such an electrode. In specific embodiments, provided herein is a method of preparing an electrode (e.g., a cathode, such as a lithium sulfur cathode) (or a battery comprising such an electrode) comprising:
a. providing a fluid stock, the fluid stock comprising a carbonaceous component (e.g., porous carbon, such as mesoporous carbon, and/or a graphenic component, such as graphene, graphene oxide or reduced graphene oxide);
b. providing a substrate (e.g., a current collector, such as comprising a conductive metal, such as aluminum or copper (e.g., a foil thereof));
c. applying an electrical charge to the fluid stock (e.g., thereby forming a charged fluid stock);
d. injecting the (e.g., charged) fluid stock into a stream of gas (or with one or more stream of gas) (e.g., forming an aerosol or plume);
e. collecting a carbonaceous deposition on the substrate.

In certain embodiments, the carbonaceous component of the fluid stock comprises mesoporous carbon. In specific embodiments, the fluid stock comprises mesoporous carbon nanofiber (MPCNF). In more specific embodiments, the fluid stock comprises mesoporous carbon nanofiber (MPCNF) (e.g., having an aspect ratio of at least 10, such as at least 100) and mesoporous carbon particles (e.g., having an aspect ratio of less than 10). In some specific embodiments, the carbonaceous component of the fluid stock comprises mesoporous carbon (e.g., MPCNF) and a graphenic component (e.g., graphene, graphene oxide, or reduced graphene oxide). In specific embodiments, the fluid stock of any iteration described herein comprises mesoporous carbon nanofibers having large mesoporous structures, such as described herein. For example, in specific embodiments, the mesoporous carbon nanofibers comprise mesopores having an average size of at least 5 nm and/or wherein the mesopores having a maximum incremental pore area (and/or volume) are at least 5 nm (e.g., at least 10 nm, at least 15 nm, at least 20 nm, or the like) in size. In certain embodiments, the fluid stock further comprises a sulfur component (e.g., elemental sulfur), such as wherein the ratio of sulfur component to carbonaceous component is about 1:9 to about 9:1, such as about 3:7 to about 7:3 or about 4:6 to about 6:4.

In certain embodiments, a process described herein further comprises:
a. providing a second fluid stock, the second fluid stock comprising a sulfur component (e.g., elemental sulfur);
b. applying an electrical charge to the second fluid stock (e.g., thereby forming a second charged fluid stock);
c. injecting the second (e.g., charged) fluid stock into a second stream of gas (or with one or more second stream of gas) (e.g., forming a second aerosol or plume);
d. collecting a sulfurous deposition on the carbonaceous deposition.

In some instances, prior to processing the second fluid stock, the carbonaceous deposition is thermally treated, such as to a temperature of at least 200 C, such as at least 300 C, at least 400 C, or the like.

Also, provided in certain embodiments herein are methods of preparing a separator-interlayer and/or a separator-ionic shield laminate.

In some embodiments, a method of preparing an integrated interlayer composition (e.g., electrode-interlayer or separator-interlayer laminate) comprises:
a. providing a fluid stock, the fluid stock comprising a carbonaceous component (e.g., porous carbon, such as mesoporous carbon, and/or a graphenic component, such as graphene, graphene oxide or reduced graphene oxide);
b. providing a separator membrane (e.g., polymer or polymer-ceramic membrane or film) or a first electrode material (e.g., lithium sulfur cathode, such as comprising mesoporous carbon and/or sulfur);
c. applying an electrical charge to the fluid stock (e.g., thereby forming a charged fluid stock);
d. injecting the (e.g., charged) fluid stock into a stream of gas (or with one or more stream of gas) (e.g., forming an aerosol or plume);
e. collecting a carbonaceous deposition on the separator material or the first electrode material.

In various embodiments, carbonaceous components are as described for the interlayer materials described herein. For example, in preferred embodiments, the carbonaceous component comprises mesoporous carbon nanofibers, mesoporous carbon powder, or a combination thereof. In certain embodiments, the carbonaceous component comprises or further comprises a graphenic component, such as graphene, graphene oxide, reduced graphene oxide, or a combination thereof.

In some embodiments, a method of preparing a separator-ionic shield composition (e.g., laminate) comprises:
a. providing a fluid stock, the fluid stock comprising a carbonaceous component (e.g., a graphenic component, such as functionalized graphene oxide or reduced graphene oxide comprising one or more polar or ionic group, such as an SOₚR_{q} group described herein (e.g., wherein p=1-4, q=1-3, and R is as described herein);
b. providing a separator film (e.g., polymer or polymer-ceramic membrane);
c. applying an electrical charge to the fluid stock (e.g., thereby forming a charged fluid stock);
d. injecting the charged fluid stock into a stream of gas (e.g., forming an aerosol or plume);
e. collecting a carbonaceous deposition on the separator material (e.g., a surface thereof).

In various embodiments, carbonaceous components are as described for the interlayer materials described herein. For example, in preferred embodiments, the carbonaceous component comprises mesoporous carbon nanofibers, mesoporous carbon powder, or a combination thereof. In certain embodiments, the carbonaceous component comprises or further comprises a graphenic component, such as graphene oxide, reduced graphene oxide, or a combination thereof.

In some embodiments, any fluid stock utilized in a process herein or a material herein further comprises any additional suitable additive. In some instances, such additives include conducting additives, carbonaceous additives, binders, and/or the like. For example, in some embodiments, manufacturing of an interlayer or ionic shield provided herein further comprises using a binder and/or conducting agent in the fluid stock and/or material. In specific embodiments, the additive is a polymer or polymer mixture, such as poly(3,4-ethylenedioxythiophene) (PEDOT) and/or polystyrene sulfonate (PSS).

In certain embodiments, provided herein are processes of manufacturing a battery (e.g., lithium sulfur battery) comprising the process steps of any process described. In specific embodiments, the process further comprises assembling the prepared material (e.g., interlayer or ionic shield containing material) into a battery, such as any battery described herein.

Also provided in various embodiments herein are separator compositions, electrode compositions, batteries, mesoporous carbon nanofibers, precursor materials, fluid stocks, aerosols, plumes, and the like as described as prepared by or preparable by any process described herein.

In certain embodiments, provided herein is a lithium battery (e.g., lithium sulfur battery) comprising a negative electrode, a separator, and a positive electrode. In specific embodiments, the lithium battery further comprises an interlayer and/or ionic shield configured between the positive electrode and the separator.

In specific embodiments, provided herein is a lithium battery (e.g., lithium sulfur battery) comprising a negative electrode, a separator, and a positive electrode, the positive electrode comprising a three dimensional porous carbon substrate, the three-dimensional porous carbon substrate comprising a mesoporous carbon (e.g., powder, paper, fibers) and a substrate surface. In specific embodiments, a sulfur compound, such as provided herein, is infused into at least a portion of the porous carbon. In more specific embodiments, a carbonaceous additive (e.g., graphene oxide or reduced graphene oxide) is deposited or coated on the surface of the porous carbon substrate. In some instances, the deposited or coated carbonaceous additive forms a film on the surface of the substrate. In further or alternative embodiments, the carbonaceous additive is deposited (e.g., with good uniformity) over the surface of the substrate, including within the porous structures found on the surface of the substrate, e.g., thereby forming a multi-domained substrate structure infused with sulfur (e.g., wherein the multi-domained substrate structure comprises a first domain comprising naked substrate and a second domain comprising substrate in combination with a carbonaceous additive). In specific embodiments, the separator of the batter is positioned between the negative electrode and the positive electrode, e.g., wherein the surface of the substrate with the additive deposition or coating thereon is positioned facing or in proximity to the separator.

In certain embodiments, an electrode and/or interlayer provided herein comprises a (e.g., three dimensional) mesoporous carbon substrate (e.g., mesoporous carbon powder, mesoporous carbon nanopowder (e.g., comprising powder particulates having an average dimension of less than 2 micron), mesoporous carbon fibers, mesoporous carbon nanofibers, mesoporous carbon paper, or the like). In certain embodiments, the mesoporous substrate comprises mesoporous voids (e.g., pores having a dimension of between 2 nm and 50 or 100 nm) within the substrate material and macroporous voids (e.g., having a dimension of greater than 50 or 100 nm) between substrate structures (e.g., between powder particulates or fiber structures). More specific and/or preferred embodiments of mesoporous structuring are described herein. In further embodiments, the mesoporous substrate comprises microporous voids (e.g., pores having a dimension of less than 2 nm) within the substrate material. In certain embodiments, the mesoporous carbon substrate collectively has a surface with an additive (e.g., a carbonaceous additive, such as graphene or an analog thereof) coated on infused in a surface thereof. In certain embodiments, at the surface of the substrate, the additive at least partially fills, coats, or otherwise incorporates within some or all of the voids or pores on the surface of the substrate (e.g., reducing the surface porosity of the substrate) (e.g., thereby forming a second—less porous—domain of the substrate). In some embodiments, an electrode provided herein comprises such a mesoporous carbon substrate coated and/or surface infused with an additive, with an active sulfur compound infused in the substrate (e.g., in the macro-, meso-, and/or micro-pores thereof).

In specific embodiments of electrodes (e.g., cathodes) herein, an interlayer and/or ionic shield is positioned between the separator and the positive electrode, such as to reduce and/or eliminate sulfur loss from the positive electrode. In specific embodiments, a battery comprises a positive electrode, an interlayer, an ionic shield and a separator, in that order. In some embodiments, the positive electrode comprises carbonaceous or conductive additive deposited into at least a portion of the pores (e.g., on a surface) thereof. In specific instances, such additive in the macroporous domain facilitates conductivity (and/or electron mobility) of the macroporous domain. In some embodiments, the additive is included in the macroporous domain in an amount sufficient to improve conductivity while not overly decreasing the porosity thereof, so as to overly decrease sulfur loading capabilities thereof.

In various embodiments, any suitable substrate is optionally utilized. In general embodiments, the substrate is a porous substrate, such as described herein. In specific embodiments, the substrate is a porous carbon substrate, such as comprising a carbon nanotube (CNT) paper, a carbon fiber paper (CFP), a gas diffusion layer (GDL) membrane, a carbon fiber mat (with or without thermal treatment), or a combination thereof.

In certain embodiments, a porous material provided herein has any suitable density. For example, in some instances, the porous material of the positive electrode and/or interlayer has a density of about 2 g/cm³ or less, or about 1 g/cm³ or less, such as 0.05 g/cm³ to about 1 g/cm³. In certain embodiments, portions of the substrates have higher densities, such as wherein a conductive and/or carbonaceous additive is deposited, such as to retard free flow of soluble polysulfides away from the positive electrode.

In certain embodiments, a positive electrode provided herein has good sulfur loading per unit area, even when using thin substrate materials, such as discussed herein. In some embodiments, a positive electrode provided herein comprises about 3 mg_{sulfur}/cm²_{electrode} or more. In more specific and preferred embodiments, the positive electrode comprises about 5 mg/cm² or more (e.g., about 6 mg/cm² or more, about 7 mg/cm² or more about 8 mg/cm² or more, about 10 mg/cm² or more, or the like) of sulfur (e.g., infused therein). In certain embodiments, even at high sulfur loading, positive electrodes provided herein exhibit good specific capacities and good capacity retention. In some embodiments, the specific capacity of a positive electrode provided herein has a specific capacity of the positive electrode is at least 200 mAh/g (e.g., at least 500 mAh/g, at least 700 mAh/g, at least 1,000 mAh/g, at least 1,250 mAh/g, or the like), such as at a charge and/or discharge rate of about 0.25 C or more (e.g., up to charge and/or discharge rates of up to 1 C, 2 C, or even 3 C or more, wherein C is the rate required to completely charge or discharge the cell in one hour). In certain embodiments, capacity retention is at least 60%, at least 80%, at least 85%, at least 90%, or more after cycling, such as after 50 cycles, after 100 cycles, after 200 cycles, after 300 cycles, or the like.

In preferred embodiments, the injection process herein is an electrospray process, such as a gas assisted or controlled process. In specific embodiments, the process comprises injecting electrostatically charged fluid stock into a stream of gas, such as to provide an electrostatically charged plume described herein. In some embodiments, the process comprises providing a pressurized gas to a second inlet of a second conduit of a nozzle (e.g., wherein a fluid stock is provided to a first inlet of a first conduit, the second conduit being positioned around the first conduit). The gas is optionally provided to the nozzle at any suitable pressure, such as to provide a high velocity gas at a second outlet of the second conduit. In specific embodiments, the high velocity gas having a velocity of about 0.5 m/s or more, about 1 m/s or more, about 5 m/s or more, or about 50 m/s or more. Any suitable configuration is optionally utilized, such as wherein the second conduit is enclosed along the length of the conduit by a second wall having an interior surface, the second conduit having a second inlet and a second outlet, the second conduit having a second diameter, and the first conduit being positioned inside the second conduit, the exterior surface of the first wall and the interior surface of the second wall being separated by a conduit gap. In certain embodiments, the ratio of the conduit overlap length to the first diameter is about 1 to 100, e.g., about 10. In certain embodiments, the first diameter is about 0.05 mm to about 5 mm (e.g., wherein V_{DC} is used), or about 1 mm or more, or about 10 mm or more (e.g., wherein V_{AC} is used). In some embodiments, the second diameter is about 0.1 mm to about 10 mm. In certain embodiments, the conduit gap is about 0.5 mm or more (e.g., wherein V_{DC} is used), or about 1 mm or more (e.g., wherein V_{AC} is used). In some embodiments, a voltage applied to the nozzle is about 8 kV_{DC} to about 30 kV_{DC}. In specific embodiments, the voltage applied to the nozzle is about 10 kV_{DC} to about 25 kV_{DC}. In other embodiments, the voltage applied to the nozzle is about 10 kV_{AC} or more (e.g., about 15 kV_{AC} or more, or about 20 kV_{AC} to about 25 kV_{AC}). In certain embodiments, the alternating voltage (V_{AC}) has a frequency of about 50 Hz to about 350 Hz. In some embodiments, the fluid stock is provided to the first inlet at a rate of about 0.01 mL/min or more, e.g., about 0.03 mL or more, about 0.05 mL or more, about 0.1 mL or more, or any suitable flow rate.

In certain embodiments, a fluid stock, plume, deposition, electrode, or the like provided herein comprises any suitable amount of additive.

Also provided in specific embodiments herein is a process for producing an material, the process comprising producing a plume, aerosol or jet from a fluid stock (e.g., by coaxially electrospraying (for depositions) or electrospinning (for nanofibers) a fluid stock with a gas, thereby forming a jet and/or a plume, e.g., the gas at least partially surrounding the jet or expelled material (e.g., from an electrospray nozzle) in a similar mean direction as the plume (e.g., within 30 degrees, within 15 degrees, or the like)), the plume comprising a plurality of droplets (e.g., nanodroplets), the fluid stock, the jet, and the plume comprising a liquid medium and additive.

In certain instances herein, a particular pore distribution is desired to fit the exact diffusion needs of a particular electrolyte or ion or the storage of a reaction product. In general, in a lithium sulfur battery, unreacted sulfur is stored on a carbon cathode and is lithiated into lithium polysulfides (Li₂Sₓ, 2<x<8) and ideally further lithiated into lithium sulfide (Li₂S) on the cathode. Lithium polysulfides greater than Li₂S₂ are well known to be soluble in the commonly used electrolytes in Li—S batteries. In some instances, micro (<2 nm) or small mesopores are important to carbon-based sulfur cathodes in organic electrolyte to resist and adsorb the dissolved lithium polysulfides from diffusing out of the cathode and to the anode. In certain instances, at the anode migrating polysulfides form an insoluble insulating lithium sulfide layer and contribute to the lithium polysulfide shuttle mechanism causing polarization and self-discharge throughout the cell. In some instances, a carbon interlayer placed between the cathode and the separator acts like a filter and a second current collector for dissolved polysulfides diffusing their way towards the anode, and thus improve the capacity and its retention for Li—S batteries. In specific instances, provided herein is a mesoporous carbon nanofiber (MPCNF) layer (e.g., discrete mat or coating) as an interlayer which has a strong affinity for polysulfides and sulfur as well as micro and mesopores for fast diffusion, high surface, and large volumes for lithium sulfide storage.

In specific embodiments herein, mesopores are templated by the phase separation of two relatively inexpensive immiscible polymers from a blended homogenous solution (e.g., polyacrylonitrile (PAN) and cellulose diacetate (CDA) or polymethylmethacrylate (PMMA)). In some embodiments, after mixing, the solution is electrospun into nanofibers where phase separation occurs. In some instances, rapid solvent evaporation during electrospinning and the physical constraints of being stretched into a nanofiber freezes the phase separation into meso-scaled domains within the fiber. In certain instances, heat treatment and carbonization of a first polymer (e.g., PAN) component of the fiber is converted to carbon while a sacrificial polymer (e.g., CDA or PMMA) component is pryolyzed leaving behind pores. In certain instances, pores made using this method are larger (>10 nm) than the typical mesopores created from templating (2-10 nm). In some instances, these larger pores are advantageous in this application. As discussed herein, in some instances, by changing the relative humidity in the electrospinning (e.g., 10% to 50%), the average size of the mesopore is adjusted between 17 and 50+ nm (see FIG. 9 and FIG. 10). In addition, in some instances, as illustrated in FIG. 16 and FIG. 22, the effect of the change in the mesopore size and microporosity on interlayer performance has an impact on enhancing the rate capability of the battery.

In some embodiments, mesoporous carbon nanofiber (e.g., mat) is used as a cathode substrate which facilitates a high amount of sulfur and conductive carbon in the substrate. Although lithium sulfur battery technology is one of the most promising next-generation battery compositions, the difficulty of achieving high loading of sulfur without sacrificing the capacity and its retention has been problems in Li—S batteries. In addition, the poor conductivity of sulfur leads to a rapid drop of the capacity at high charge rates. In some instances, by depositing highly conductive carbon and sulfur onto and into a mesoporous carbon nanofiber substrate via gas-assisted electrospray, controlled distribution of conductive carbon (e.g., mesoporous carbon, such as KB) and highly loaded sulfur component (e.g., into meso and micro pores) is achieved. In some instances, such good distribution and high loading facilitates high capacity, good capacity retention, and excellent rate capabilities. In some embodiments, sulfur component loading is at least 5 mg/cm², such as with a capacity of about 1,000 mAh/g or more (e.g., at C/2) and/or a good capacity retention.

In some embodiments, mesoporous carbon nanofibers (e.g., as a discrete mat or integrated film) as interlayers for lithium sulfur batteries greatly improve capacity retention, such as by adsorbing polysulfides diffusing out the cathode to the anode. In some instances, adsorbing the polysulfides before they reach the lithium anode facilitate the reduction or prevention of the formation of an electrically insulating lithium sulfide layer from forming on the anode surface and reduce or prevent participation in the polysulfide shuttle mechanism. In some embodiments, a conductive carbon interlayer (e.g., interlayer comprising mesoporous carbon nanofiber and a conductive carbon, such as conductive mesoporous carbon particles (e.g., KB)), adsorbed polysulfides are still available as an active material for future cycles. In some instances, creating conductive mesoporous carbon nanofibers with tunable pores from immiscible blended polymers described herein is a cost-efficient way to make an effective interlayer with a significant improvement to capacity and rate capabilities.

These and other objects, features, and characteristics of the batteries, electrodes, materials, compositions and/or processes disclosed herein, will become more apparent upon consideration of the following description and the appended claims with reference to the accompanying drawings and examples, all of which form a part of this specification. It is to be expressly understood, however, that the drawings and examples are for the purpose of illustration and description only and are not intended as a definition of the limits of the invention. As used in the specification and in the claims, the singular form of “a”, “an”, and “the” include plural referents unless the context clearly dictates otherwise.

The term “alkyl” as used herein, alone or in combination, refers to an optionally substituted straight-chain, or optionally substituted branched-chain saturated or unsaturated hydrocarbon radical. Examples include, but are not limited to methyl, ethyl, n-propyl, isopropyl, 2-methyl-1-propyl, 2-methyl-2-propyl, 2-methyl-1-butyl, 3-methyl-1-butyl, 2-methyl-3-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, n-butyl, isobutyl, sec-butyl, t-butyl, n-pentyl, isopentyl, neopentyl, tert-amyl and hexyl, and longer alkyl groups, such as heptyl, octyl and the like. Whenever it appears herein, a numerical range such as “C1-C6 alkyl,” means that: in some embodiments, the alkyl group consists of 1 carbon atom; in some embodiments, 2 carbon atoms; in some embodiments, 3 carbon atoms; in some embodiments, 4 carbon atoms; in some embodiments, 5 carbon atoms; in some embodiments, 6 carbon atoms. The present definition also covers the occurrence of the term “alkyl” where no numerical range is designated. In certain instances, “alkyl” groups described herein include linear and branched alkyl groups, saturated and unsaturated alkyl groups, and cyclic and acyclic alkyl groups.

The term “heteroalkyl” as used herein refers to optionally substituted alkyl structure, as described above, in which one or more of the skeletal chain carbon atoms (and any associated hydrogen atoms, as appropriate) are each independently replaced with a heteroatom (i.e. an atom other than carbon, such as though not limited to oxygen, nitrogen, sulfur, silicon, phosphorous, tin or combinations thereof), or heteroatomic group such as though not limited to —O—O—, —S—S—, —O—S—, —S—O—, ═N—N═, —N═N—, —N═N—NH—, —P(O)2-, —O—P(O)2-, —P(O)2-O—, —S(O)—, —S(O)2-, —SnH2- and the like.

In certain instances, a value “about” an indicated value is a value suitable for achieving a suitable result and/or a result similar as achieved using the identified value. In some instances, a value “about” an indicated value is between ½ and 2 times the indicated value. In certain instances, a value “about” an indicated value is ±50% the indicated value, ±25% the indicated value, ±20% the indicated value, ±10% the indicated value, ±5% the indicated value, ±3% the indicated value, or the like.

In certain instances, graphenic components are provided and described herein. In general, a graphenic component is a two-dimensional, sheet-like or flake-like carbon form that comprises monolayer graphenes, as well as multi-layer graphenes (e.g., graphenes comprising 1 up to about 40 graphenic layers, such as 1 to about 25 or 1 to about 10 graphenic layers), as opposed to three dimensional carbon structures, such as graphite, and one dimensional structures, such as carbon nanotubes (CNTs), and zero dimensional structures, such as C60 buckyball. A pristine graphenic layer is a single-atom-thick sheet of hexagonally arranged, sp2-bonded carbons atoms occurring within a carbon material structures, regardless of whether that material structure has a 3D order (graphitic) or not. As discussed herein, graphenic components optionally comprise pristine and/or defective or functionalized graphenic layers. For example, defective graphene layers may be optionally functionalized, such as described herein. In some instances, graphene layers are functionalized with oxygen and/or other moieties. For example, graphene oxide is an oxygen functionalized graphene or a chemically modified graphene prepared by oxidation and exfoliation that is accompanied by extensive oxidative modification of the basal plane. Herein, graphene oxide is a single or multi-layered material with high oxygen content, such as characterized by C/O atomic ratios of less than 3.0, such as about 2.0. Reduced graphene oxide (rGO) is graphene oxide that has been reductively processed by chemical, thermal, microwave, photo-chemical, photo-thermal, microbial/bacterial, or other method to reduce the oxygen content. Oxygen content of rGO isn't necessarily zero, but is typically lower than the oxygen content of graphene oxide, such as having a C/O atomic ratio of over 3.0, such as at least 5, at least 10, or the like. In certain instances, graphene layers of rGO are less pristine than that of graphene, such as due to imperfect reduction and assembly of the two-dimensional structure. FIG. 25 and FIG. 26 illustrate non-limiting examples of possible GO and rGO structures, respectively.

### BRIEF DESCRIPTION OF THE DRAWINGS

FIG. 1 illustrates the performance of an exemplary lithium sulfur battery provided herein using an electrode system comprising a mesoporous cathode substrate and a mesoporous interlayer.

FIG. 2 illustrates the performance of exemplary lithium sulfur battery provided herein using an electrode system with and without a mesoporous interlayer.

FIG. 3 illustrates the performance of an exemplary lithium sulfur battery with and without a graphenic interlayer component.

FIG. 4 illustrates the performance of an exemplary lithium sulfur battery (a) with a graphenic (GO) interlayer component and one mesoporous carbon interlayer component, (b) without a graphenic (GO) interlayer component and with a mesoporous carbon interlayer component, and (c) without a graphenic (GO) interlayer component and with three mesoporous carbon interlayer components (layers).

FIG. 5 illustrates exemplary configurations of lithium sulfur battery systems and electrode systems provided herein.

FIG. 6 illustrates cell performance characteristics of exemplary lithium sulfur battery (a) with a graphenic (rGO) interlayer component and one mesoporous carbon interlayer component, and (b) without a graphenic (rGO) interlayer component and with a mesoporous carbon interlayer component.

FIG. 7 illustrates exemplary battery performances of exemplary lithium sulfur battery (a) with mesoporous carbon interlayer component, (b) with a non-mesoporous carbon interlayer component, and (c) without an interlayer component.

FIG. 8 illustrates a schematic of small vs. large mesopores and the effect, in some instances, of the charging rate.

FIG. 9 illustrates incremental pore area characteristics of various mesoporous carbon nanofibers prepared according to processes and/or used in compositions described herein.

FIG. 10 illustrates incremental pore volume characteristics of various mesoporous carbon nanofibers prepared according to processes and/or used in compositions described herein.

FIG. 11 illustrates TEM images of (a) a cross section of exemplary mesoporous carbon nanofibers prepared by pyrolyzing an exemplary polymer blend nanofibers spun at 10% RH, (b) a longitudinal section of an exemplary mesoporous carbon nanofiber prepared by pyrolyzing an exemplary polymer blend nanofiber spun at 10% RH, (c) a cross section of exemplary mesoporous carbon nanofibers prepared by pyrolyzing an exemplary polymer blend nanofibers spun at 30% RH, (d) a longitudinal section of an exemplary mesoporous carbon nanofiber prepared by pyrolyzing an exemplary polymer blend nanofiber spun at 30% RH, (e) a cross section of exemplary mesoporous carbon nanofibers prepared by pyrolyzing an exemplary polymer blend nanofiber spun at 50% RH, (b) a longitudinal section of an exemplary mesoporous carbon nanofiber prepared by pyrolyzing an exemplary polymer blend nanofiber spun at 50% RH, (g) a cross section of exemplary non-mesoporous carbon nanofibers prepared by pyrolyzing an exemplary polymer nanofiber, (h) a longitudinal section of an exemplary non-mesoporous carbon nanofiber prepared by pyrolyzing an exemplary polymer nanofiber.

FIG. 12 illustrates an exemplary schematic of a process whereby lithium sulfur electrode is prepared using an electrode substrate comprising mesoporous carbon nanofibers.

FIG. 13 illustrates the voltage and specific capacity of a lithium sulfur battery prepared using a lithium metal anode and an exemplary cathode comprising a sulfur component, mesoporous carbon, and a carbon additive (KB).

FIG. 14 illustrates the specific capacity of a lithium sulfur battery prepared using a lithium metal anode and an exemplary cathode comprising a sulfur component, mesoporous carbon, and a carbon additive (KB).

FIG. 15 illustrates the excellent rate capabilities of a lithium sulfur battery prepared using a lithium metal anode and an exemplary cathode comprising a sulfur component, mesoporous carbon, and a carbon additive (KB).

FIG. 16 illustrates the capacity of exemplary lithium sulfur batteries using carbon interlayers having a variety of porous morphologies.

FIG. 17 illustrates capacity measures of lithium sulfur batteries as a function of interlayer mass.

FIG. 18 illustrates capacity relative to sulfur percentage in an electrode system (electrode plus interlayer) for a variety of different interlayer loadings.

FIG. 19 illustrates an exemplary schematic of the manufacture of an exemplary mesoporous carbon substrate and cathode.

FIG. 20 illustrates the areal capacity of exemplary lithium sulfur batteries with high sulfur loading relative to targeted capacities.

FIG. 21 illustrates the capacity and Coulombic efficiences of exemplary lithium sulfur batteries provided herein.

FIG. 22 illustrate the capacity of various exemplary batteries, including lithium sulfur batteries comprising active and not activated mesoporous carbon interlayers as well as a lithium sulfur battery an activated non-mesoporous carbon interlayer.

FIG. 23 illustrates an exemplary battery configuration provided herein utilizing such an electrolyte system.

FIG. 24 illustrates an exemplary battery configuration comprising separator laminate comprising a porous polymer film and exemplary secondary layers (e.g., a sulfonated graphene oxide and/or PEDOT and/or PSS).

FIG. 25 illustrates exemplary graphene oxide (GO) structures, including the basic honeycomb lattice structure, with defects therein.

FIG. 26 illustrates exemplary reduced graphene oxide (rGO) structures, including the basic honeycomb lattice structure, with defects therein.

### DETAILED DESCRIPTION OF THE INVENTION

Provided in certain embodiments herein are energy storage devices (e.g., lithium batteries, such as lithium-sulfur batteries), component parts thereof, and methods of manufacturing the same. In specific embodiments, the energy storage device comprises and electrode and/or electrode materials described herein and/or prepared according to the manufacturing processes described herein. In some embodiments, provided herein is an electrode material comprising a porous material, such as provided herein, and a sulfur component. In specific embodiments, the porous material further comprises an additive, such as a carbon and/or conductive additive. In some embodiments, provided herein is an electrode system comprising an electrode material, such as described above, and an interlayer (e.g., comprising a mesoporous carbon material). In some embodiments, the electrode system further comprises one or more graphenic additive or layer, such as configured between the electrode substrate and the interlayer (e.g., comprising graphene oxide or reduced graphene oxide) and/or between the interlayer and the separator (e.g., comprising functionalized graphenic component comprising one or more ionic shielding group). In some instances, the graphenic components are configured within the electrode substrate and/or within the interlayer, such as forming a graphenic web therein. In various embodiments, such materials and/or layers are independently discrete and/or affixed to each other (e.g., forming a laminate).

In certain embodiments, provided herein is interlayer, ionic shield, combinations thereof with a battery component (e.g., electrode or separator), batteries comprising the same, and the like. In some embodiments, an interlayer provided herein comprises a porous material, particularly a mesoporous material (e.g., mesoporous carbon nanofibers, mesoporous carbon powder, or a combination thereof), such as configured between an electrode and separator. In specific instances, the interlayer is a discrete body (e.g., separate from the electrode and separator), such as within a battery. In other specific instances, the interlayer is affixed to or otherwise incorporated onto the surface of the electrode and/or separator (e.g., deposited thereon, such as by electrospray techniques described herein), such as forming a laminate therewith or a coating thereon. In some embodiments, an interlayer comprises a mesoporous substrate material, such as mesoporous carbon, in combination with an ionic shield. In certain embodiments, the ionic shield is configured between the porous body and the separator, and the porous body being configured between the ionic shield and the electrode. In other embodiments, the ionic shield and the porous body are integrated.

In certain embodiments, provided herein is an interlayer that comprises a mesoporous carbon, such as mesoporous carbon nanofibers or a mat thereof, and/or a graphenic component, such as graphene, graphene oxide, reduced graphene oxide, or a functionalized graphene, such as functionalized with a polar or ionic component. In some embodiments, the interlayer comprises both a mesoporous carbon and a graphenic component. In certain embodiments, the mesoporous carbon is configured between the separator and an electrode (e.g., a lithium sulfur cathode). In certain embodiments, the mesoporous carbon is configured into a body, such as a nanofiber mat or a deposition or film, wherein the graphenic component is configured on the surface thereof, such as laminated or coated thereon. In some embodiments, the graphenic component is configured on the surface thereof, such as laminated or coated on the surface of a separator (e.g., covering at least 50%, at least 60%, at least 70%, at least 80%, at least 90% or the like of the surface (by area) thereof).

In certain embodiments, the graphenic component or ionic shield comprises a polar or ionic component suitable for repelling negatively charged polysulfides, particularly those soluble in electrolyte. In certain embodiments, the ionic shield comprises a functionalized graphene component, such as a graphene oxide or reduced graphene oxide comprising a strong acid group (including a conjugate base thereof), such as a sulfonate (sulfonic acid) or a sulfinate (e.g., sulfinic acid). In some embodiments, an ionic shield provided herein comprises a negative charged polymer, such as a polymer comprising a sulfonate, a sulfonate, or the like, such as polystyrene sulfonate (PSS).

In some instances, configurations provided herein facilitate high sulfur loading, good capacity retention (and/or retention of sulfur—particularly electrolyte soluble polysulfides that are formed during cell cycling—by or at the electrode), good rate capabilities (e.g., due to the much lower provelance of sulfur/polysulfide to migrate to the anode), and/or the like.

In some instances, the interlayer and/or ionic shield (e.g., of an interlayer) facilitates transfer of lithium ions, while retarding the transfer of sulfur therethrough. In certain embodiments, the loss of sulfur is reduced by at least 10%, at least 20%, at least 30%, at least 40%, at least 50%, at least 60%, at least 70%, at least 80%, at least 90%, at least 95%, or more relative to an otherwise identical electrode (or electrode comprising the same amount of substrate as the electrode and interlayer substrates when taken together) when cycled in a cell (e.g., lithium battery cell, such as a lithium-sulfur cell) lacking the interlayer after a number of cycles (e.g., after 10 cycles, after 20 cycles, after 50 cycles, after 100 cycles, after 150 cycles, or more). In some embodiments, the interlayer comprises an ionic shielding component or layer suitable for retaining and/or prohibiting or reducing the free flow of sulfur (e.g., across the separator).

In some instances, provided herein is a lithium sulfur battery comprising an interlayer, such as a mesoporous carbon interlayer (e.g., nanofibers and/or particles, such as having characteristics described herein). FIG. 16 and FIG. 22 illustrate the capacity of various exemplary batteries, including a lithium sulfur battery comprising a lithium sulfur battery comprising an interlayer comprising carbon nanofibers (micropore only), and lithium sulfur batteries comprising an interlayer comprising various mesoporous carbon materials (e.g., nanofibers). As illustrated in FIG. 16, the larger mesoporous structures (50% RH) provide even excellent cell performance, even at charge rates as high as 3 C. Moreover, as illustrated in FIG. 22, in certain instances, activation of the mesoporous carbon utilized in the interlayer (e.g., forming micropores and/or high surface area thereof) significantly improves the performance parameters of the electrode system.

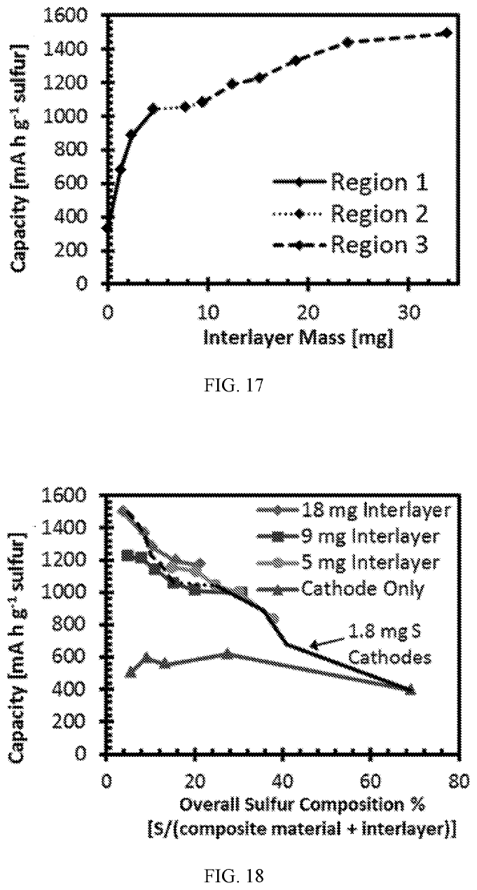

Moreover, any suitable mass of interlayer is utilized in a cell provided herein. Preferably, the amount of interlayer utilized is low, so as to improve overall cell energy density, but enough interlayer is utilized in order to achieve the desired cell performance parameters. As illustrated in FIG. 17, at low amounts of interlayer, poor performance is achieved, with increasing amounts of interlayer rapidly leading to improved results. After a time, however, diminish improvements are observed as additional interlayer mass is included. FIG. 18 illustrates that by including an interlayer structure, the amount of cathode substrate can be reduced. As is illustrated, when different masses of interlayers are compared across the overall sulfur composition by manipulating the amount of active material.

In certain embodiments, an electrode system (e.g., comprising a positive electrode and interlayer, the interlayer being discrete or affixed to the electrode and/or a separator) comprises a first material (e.g., loaded with sulfur and an additive, such as a conductive material (e.g., to facilitate electrical conductivity, rate capability, and/or eliminate the need for an additional current collector component in a cell)) and a second (e.g., porous) material (e.g., with no loading or lower (e.g., less than ½, less than ¼, less than 1/10, or the like) loading of sulfur than the first porous material, and an optional additive, such as a graphenic component and/or ionic shielding component), the first material being porous (e.g., comprising mesoporous carbon, such as described herein). In some instances, the second material comprises a mesoporous carbon component and/or a graphenic component, such as described for interlayers herein.

Any suitable porous material is optionally used, such as carbon substrate, preferably a porous carbon substrate. In some embodiments, the first material comprises a porous (e.g., macro- and/or meso-porous) structure suitable for receiving, and/or being infused with sulfur. In certain embodiments, the first material has any suitable thickness, such as about 10 micron to about 10 mm, e.g., about 75 micron or more, about 100 micron to about 1 mm, about 100 micron to about 500 micron, or about 200 micron to about 400 micron.

In some embodiments, any porous material provided herein (e.g., in the electrode and/or interlayer) has a void fraction porosity of about 10% or more (e.g., about 20% or more, about 30% or more, about 40% or more, about 50% or more, or the like). In some embodiments, macrostructured pores (e.g., voids having at least one dimension, or an average dimension, of about 50 nm or more, such as about 50 nm to about 500 micron) and/or mesopores (e.g., voids having at least one dimension, or an average dimension, of about 2 nm to about 50 nm) constitute about 20% or more (e.g., about 30% or more, about 40% or more, about 50% or more, about 60% or more, about 70% or more, or the like) of the void fraction porosity of the three dimensional porous substrate (e.g., of the first layer or first domain thereof) (e.g., porous carbon substrate). In specific embodiments, macrostructured pores (e.g., voids having at least one dimension, or an average dimension, of about 50 nm or more, such as about 50 nm to about 500 micron) constitute about 20% or more (e.g., about 30% or more, about 40% or more, about 50% or more, about 60% or more, about 70% or more, or the like) of the void fraction porosity of the three dimensional porous substrate.

In certain embodiments, more porous substrates (e.g., comprising larger pore sizes) are desired such as to facilitate high sulfur loading into the substrate (e.g., first layer or first domain thereof). In some instances, however, porosity readily leads to migration of sulfur out of the electrode material, which may lead to loss of capacity in a cell and/or even cell death. In some embodiments, the porosity of the interlayer is less than the porosity of the electrode substrate, such as at least 5% less porous, at least 10% less porous, at least 20% less porous, at least 30% less porous, at least 50% less porous, or the like.

In certain embodiments, electrode system comprises a porous electrode substrate and an interlayer (e.g., electrode substrate loaded with sulfur component and interlayer lacking or with reduced sulfur component loading). In some embodiments, the electrode substrate and the interlayer are different (e.g., comprising different components, having different porosity, and/or the like). For example, while the electrode substrate and interlayer may both comprise porous carbon, the electrode substrate may be carbon paper, whereas the interlayer comprises mesoporous nanofibers and/or mesoporous powder. In some embodiments, the electrode substrate and/or interlayer further comprise an additive, such as a graphenic component (e.g., an oxidized graphene, such as GO or rGO). In specific embodiments, the interlayer comprises a graphenic component, such as a functionalized graphenic component described herein (e.g., functionalized with one or more ionic shielding group). In some embodiments, the additive is a conductive additive, whereby the additive is useful, in some instances, for improving conductivity of the substrate (such as improving the rate capabilities of an electrode comprising the such a substrate), reducing the porosity at the surface of the substrate (e.g., facilitating improved retention of the sulfides at the cathode), and/or facilitating repulsion of soluble sulfides (e.g., facilitating improved retention of sulfides at the cathode). In certain instances, the interlayer and cathode further comprise different sulfur loading. In some instances, upon manufacture, the cathode is highly loaded with sulfur, whereas the interlayer is not loaded with sulfur. In certain instances, during operation of a battery comprising such a cathode, sulfur component may partially migrate into the interlayer, but the loading (weight per unit area and/or volume) of the sulfur component in the cathode is higher than that of the interlayer. In some instances, the loading (weight per unit area and/or volume) of sulfur component in the cathode is at least 2 times, at least 3 times, at least 4 times, at least 5 times, at least 10 times, at least 20 times or the like greater than loading of the interlayer.

In certain embodiments, the weight percentage of sulfur component in the electrode system (comprising both substrate and interlayer components) is about 10 wt. % or more, such as about 10 wt. % to about 80 wt. %, about 10 wt. % to about 60 wt. %, or about 10 wt. % to about 50 wt. %. In specific embodiments, the weight percentage of sulfur component in the electrode system is about 20 wt. % to about 40 wt. %. In other specific embodiments, the weight percentage of sulfur component in the electrode system is about 30 wt. % to about 60 wt. %.

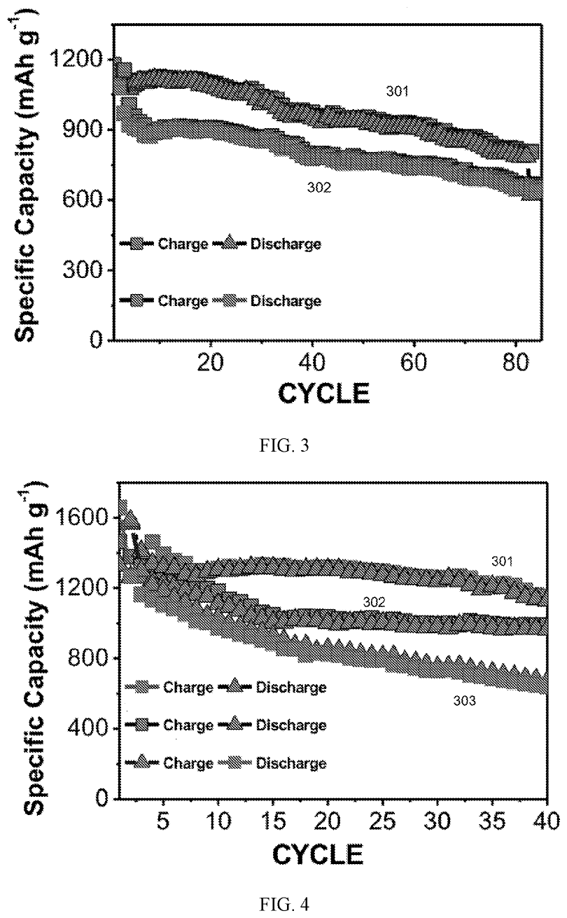

In certain embodiments, an electrode system provided herein comprises an electrode, the electrode comprising an electrode substrate (e.g., comprising mesoporous carbon and a carbon and/or conducting additive, such as carbon black) and a sulfur component, and an interlayer component. In specific embodiments, the interlayer component comprises a mesoporous interlayer component (e.g., comprising mesoporous carbon) and/or an additive (e.g., graphenic additive). In more specific embodiments, the interlayer component comprises a mesoporous interlayer component (e.g., comprising mesoporous carbon) and an additive (e.g., graphenic additive), the additive being configured between the electrode substrate and the mesoporous interlayer component. In some instances, the additive is a carbon, graphenic, and/or conducting additive, such as graphene oxide, reduced graphene oxide, functionalized graphene, and/or combinations thereof. FIG. 4 illustrates performance parameters of various positive electrode system configurations, including (a) a sulfur loaded substrate comprising mesoporous carbon (nanofibers), a graphenic thin layer (graphene oxide) configured between the substrate and mesoporous interlayer component, and a single mesoporous interlayer component (comprising mesoporous carbon nanofibers); (b) a sulfur loaded substrate comprising mesoporous carbon (nanofibers), no graphenic thin layer (graphene oxide) configured between the substrate and mesoporous interlayer component, and a single mesoporous interlayer component (comprising mesoporous carbon nanofibers); and (c) a sulfur loaded substrate comprising mesoporous carbon (nanofibers), no graphenic thin layer (graphene oxide) configured between the substrate and mesoporous interlayer component, and three mesoporous interlayer components (comprising mesoporous carbon nanofibers). As illustrated, the electrode system with an interlayer with a graphenic layer and mesoporous interlayer component demonstrated the best performance characteristics, whereas a similar electrode system with an interlayer comprising no graphenic layer performed less well, and the electrode system comprising an interlayer with three mesoporous interlayer components performed much worse than both (a) and (b). As illustrated in FIG. 3, beneficial results are observed when including a graphenic layer even when carbon paper is utilized as the electrode and interlayer substrate material.

Also provided in certain embodiments herein are electrode materials, such as lithium sulfur cathode material. In some instances, such cathodes are configured in combination with an interlayer, such as forming an electrode system described herein. However, in other embodiments, cathodes provided herein are provided and contemplated in the absence of such an interlayer. In some instances, a lithium sulfur electrode (cathode) provided herein comprises a substrate component (e.g., carbon, such as conductive and/or mesoporous carbon) and a sulfur component (e.g., elemental sulfur, sulfides, etc.). In some instances, the electrode further comprises a conductive additive (e.g., a graphenic component).

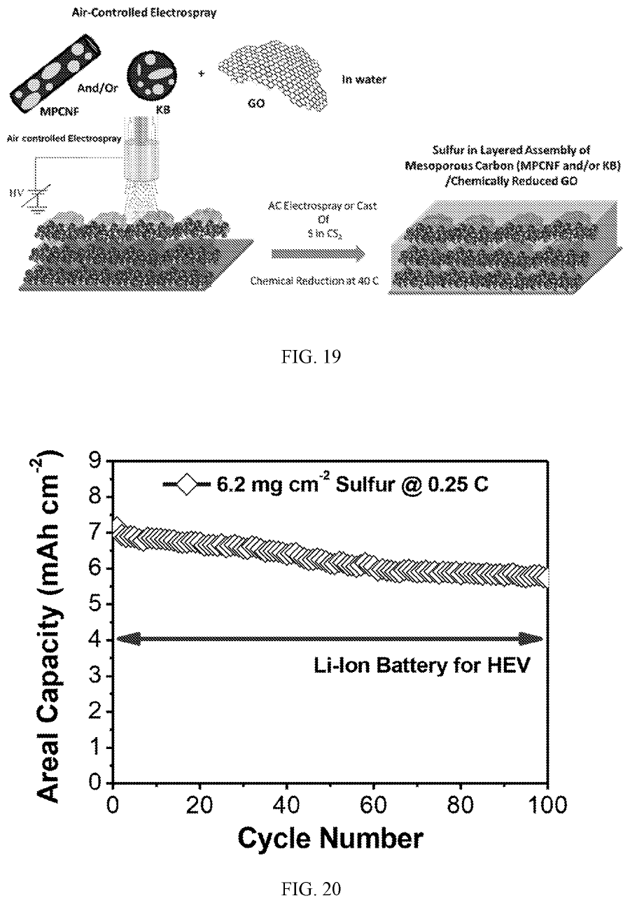

FIG. 19 illustrates an exemplary schematic of the manufacture of a mesoporous carbon (electrode) substrate provided herein. In FIG. 19, the production of an electrode is specifically described, but similar techniques (e.g., with or without a graphenic component) can also be utilized to produce an interlayer provided herein. As illustrated, in some embodiments, a mesoporous substrate (e.g., electrode and/or interlayer) is prepared by injecting a fluid stock into a gas stream (e.g., via electrospray) and collecting a mesoporous substrate on a collector (e.g., a current collector or separator). In some instances, the fluid stock further comprises an additive, such as a graphenic additive (e.g., reduced graphene oxide, graphene oxide, a functionalized graphene, or the like). In various embodiments, (e.g., in the case of an electrode) a sulfur component is added to the substrate following the formation of the mesoporous carbon substrate layer. The sulfur component is infused into the substrate layer using any suitable technique, such as electrospraying (e.g., with a gas stream), casting, or the like. In some instances, the process further comprises reducing the graphenic component (e.g., graphene oxide), such as using chemical and/or thermal reductive techniques.

In certain embodiments, provided herein is a process of manufacturing a battery electrode, electrode system, or material (e.g., electrode substrate) thereof, the process comprising injecting a fluid stock into a gas stream (e.g., gas-assisted electrospraying) and collecting a (e.g., electrospray) deposition or (e.g., thin) film (e.g., electrode substrate or precursor thereof) on a collector (e.g., a current collector, separator, or other collector, which may later be removed before assembling into a battery cell). In specific embodiments, the fluid stock comprises a mesoporous carbon component and a graphenic component, such as graphene oxide, graphene, or the like.

In certain embodiments, the deposition, film, electrode, or electrode material provided herein comprises a composite or mixture of mesoporous carbon component and graphenic component. In some embodiments, the bulk comprises the mesoporous carbon component (e.g., at least 50 wt. %, at least 60 wt. %, at least 70 wt. %, at least 80 wt. %, at least 90 wt. %, at least 95 wt. % of the combination of mesoporous carbon component and graphenic component is mesoporous carbon), with at least a portion of the graphenic component being within (e.g., embedded within) that bulk. In some instances, a portion of the graphenic component is also found on the surface of the bulk. In certain embodiments, at least 30 wt. %, at least 50 wt. %, at least 70 wt. %, at least 80 wt. %, or the like of the graphenic component is within (e.g., embedded within) a deposition, film, electrode, or electrode material provided herein.

In some instances, the mesoporous carbon component and the graphenic component are uniformly deposited on the substrate, providing a good scaffold for sulfur loading (e.g., the mesoporous carbon component) with good conductivity throughout (e.g., from the uniformly dispersed graphenic component). In specific embodiments, the mesoporous carbon component of the fluid stock and/or the electrode, electrode system, or material (e.g., electrode substrate) thereof comprises mesoporous carbon nanofiber (MPCNF), preferably having the large mesopores described herein. In more specific embodiments, the mesoporous carbon component of the fluid stock and/or the electrode, electrode system, or material (e.g., electrode substrate) thereof comprises mesoporous carbon nanofiber (MPCNF), preferably having the large mesopores described herein, and mesoporous carbon particles (e.g., having an aspect ratio of less than 10, less than 5, less than 2, or the like). In certain embodiments, the fluid stock further comprises a liquid medium. Any suitable liquid medium is optionally utilized, such as water, dimethyl formamide (DMF), N-methyl-2-pyrrolidone (NMP), carbon disulfide (CS2), combinations thereof, or the like.

In various embodiments, a sulfur component is added to the substrate during and/or following the formation of the mesoporous carbon substrate layer. In some instances (e.g., wherein the substrate is infused with sulfur during manufacture of the substrate), the fluid stock comprises a mesoporous carbon component, a graphenic component (e.g., graphene or reduced graphene oxide), and a sulfur component.

In some instances, wherein sulfur is added following manufacture of the electrode substrate, the sulfur component is infused into the substrate layer using any suitable technique, such as electrospraying (e.g., with a gas stream), casting, or the like. In certain instances, the benefit of manufacturing the substrate prior to infusion with sulfur is that thermal treatment is optionally utilized thereof (e.g., to reduce graphene oxide, or the like). In some instances, the process further comprises chemical and/or thermal treating the deposited material, such as using reductive techniques to reduce the graphenic component. By contrast, in some instances, the benefit of manufacturing the substrate concurrent with infusion of the sulfur is that the process involves fewer steps, improving yield and throughput, and/or reduced costs.

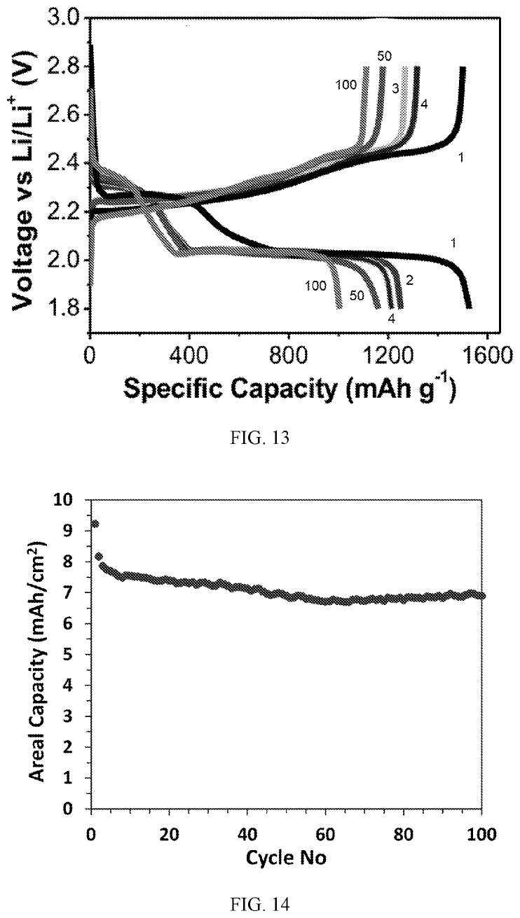

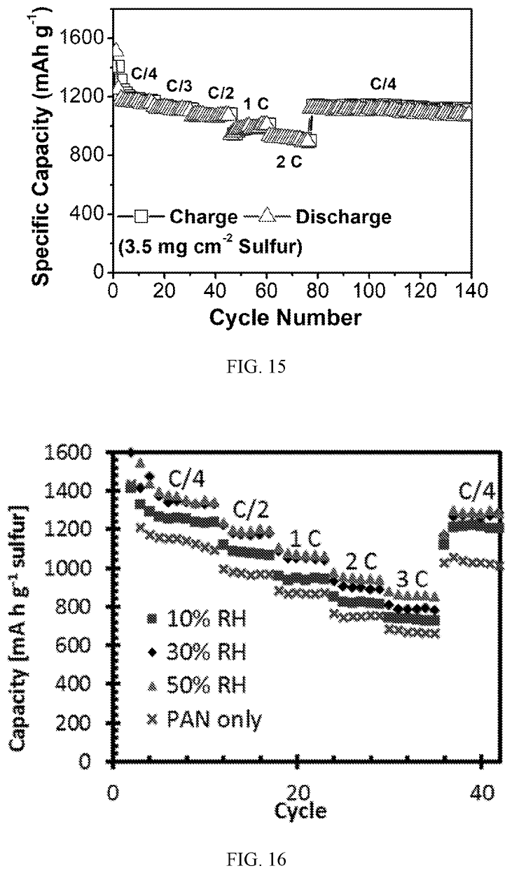

FIG. 12 illustrates an exemplary schematic of a process whereby lithium sulfur electrode is prepared using an electrode substrate comprising mesoporous carbon nanofibers. As is illustrated, in some instances, an electrode substrate is provided, the electrode substrate comprising mesoporous carbon (e.g., comprising mesoporous carbon nanofibers). A liquid stock of a sulfur component (e.g., sulfur in carbon disulfide) and an additive (e.g., a conductive carbon) is provided and electrosprayed onto the substrate, with the assistance of a high-speed gas. FIG. 13 illustrates the specific capacity of a lithium sulfur coin cell prepared using a lithium metal anode and an exemplary cathode comprising a sulfur component, mesoporous carbon, and a conducting additive. As is illustrated, very good specific capacities (even at the high loading of 5-6 mg/cm²) are achieved. Moreover, FIG. 14 illustrates the good capacity retention of such a cell. FIG. 15 illustrates the excellent rate capabilities of similar cells.

In some embodiments, provided herein are lithium ion battery cathodes, lithium ion (e.g., lithium-sulfur or silicon-sulfur) battery cathode systems (e.g., comprising a substrate (initially) loaded with a sulfur component and an interlayer (initially) not loaded with a sulfur component), and parts thereof.

In specific embodiments, provided herein is a lithium sulfur electrode (cathode) comprising (a) a carbon substrate comprising mesoporous carbon and (b) a sulfur component (e.g., infused within the carbon substrate). In specific embodiments, the mesoporous carbon comprises mesoporous carbon nanofibers. In more specific embodiments, the mesoporous carbon comprises mesoporous carbon nanofibers and mesoporous carbon particles (e.g., Ketjen Black (KB) and/or having average mesopore size of less than 20 nm). Any suitable specific mesoporous morphologies/dimensions of the mesoporous carbon are utilized, such as described herein. In some embodiments, the carbon substrate further comprises a graphenic component, such as reduced graphene oxide, graphene oxide, or a functionalized graphene, such as described herein. In specific embodiments, the surface of the carbon substrate is at least 80% (by area) graphenic component, at least 90% graphenic component, or the like. In some embodiments, provided herein is a carbon substrate (e.g., an electrode substrate provided herein, which may be loaded with sulfur, such as according to the descriptions provided herein) comprising a three dimensional graphenic web (e.g., forming pockets therein) within which the mesoporous carbon is secured (e.g., within the graphenic pockets), such as illustrated in FIG. 19.

In some embodiments, the electrode, interlayer, graphenic layer, mesoporous interlayer component, and/or ionic shield have any suitable length, width, and thickness. Generally, the interlayer covers the electrode fairly well, e.g., so as to maximize sulfur retention at the electrode, and such dimensions are generally a function of the ultimate cell in which the electrode is to be used, and the electrode packing configuration thereof. The thicknesses of the electrode or substrate and the interlayer thereof may, however, differ. In specific instances, it is desirable to have an electrode or substrate thereof with a thickness sufficient to allow desired infusion of sulfur component therein. In some instances, the interlayer has a thickness sufficient to adequately retard the loss of sulfur therethrough (e.g., while not overly retarding the flow of lithium therethrough). In preferred embodiments, the interlayer is as thin as possible in order to improve overall gravimetric and/or volumetric energy density of the battery cell.

In certain embodiments, the thickness of the electrode or substrate thereof is greater than the thickness of the interlayer, e.g., the ratio of the thickness of the electrode or substrate thereof to thickness of the interlayer being at least 1:2, e.g., at least 1:1, at least 2:1, at least 3:1, at least 4:1, or the like. In certain instances, such as for determining interlayer thickness, the interlayer comprises anything, including graphenic layer(s), mesoporous carbon layer(s), polymeric, ionic shielding layer(s), integrated layers comprising any one or more of the preceding, or the like, configured between the cathode (or substrate thereof) and the separator.

As discussed herein, in certain embodiments, the electrode and/or interlayer or substrate thereof is a conductive substrate, e.g., comprising carbon. In specific embodiments, the electrode or substrate thereof is a carbon substrate comprising, e.g., carbon nanotube (CNT) paper, a carbon fiber paper (CFP), a carbon fiber mat, mesoporous carbon (e.g., pitted mesoporous carbon), or the like.

In some embodiments, the electrode and/or interlayer comprises a conductive substrate. In certain embodiments, the interlayer comprises a carbon material, such as a carbon allotrope. In some embodiments, the interlayer comprises a carbon web. In specific embodiments, the interlayer comprises conductive carbon, such as conductive nanostructured carbon. In some embodiments, the interlayer comprises the same porous substrate (e.g., carbon substrate) of the electrode substrate and an additive, such as a conducting additive and/or graphenic component, such as an oxidized graphene or functionalized graphenic component comprising one or more ionic shielding group. In some embodiments, the electrode and/or interlayer comprises carbon black (e.g., Super P™, or Ketjenblack (KB)), a graphenic component or analog, (e.g., graphene oxide, reduced graphene oxide, graphene nanoribbons (GNR), a functionalized graphenic component, or the like), carbon nanotubes (CNT), or the like, or any combination thereof.

In certain embodiments, a substrate material provided herein (e.g., of an electrode and/or interlayer herein) has any suitable characteristic(s). In some embodiments, the substrate systems (e.g., porous carbon substrate systems) of an electrode provided herein allow for high loading of sulfur (e.g., even when thin substrate systems are utilized), with very good capacity retention. In certain embodiments, a lithium battery (e.g., lithium-sulfur battery)) comprises an electrode or electrode material provided herein (e.g., as the cathode thereof).

In certain embodiments, high sulfur loading is achieved, e.g., about 1 mg/cm² to about 20 mg/cm², about 2 mg/cm² to about 10 mg/cm², about 3 mg/cm² to about 8 mg/cm², about 5 mg/cm² to about 7 mg/cm², about 5 mg/cm² to about 10 mg/cm², about 1 mg/cm² or more, about 3 mg/cm² or more, about 5 mg/cm² or more, or about 6 mg/cm² or more. In specific instances, such loading achieved using an electrode or electrode material (e.g., substrate thereof) that is about 1 mm in thickness or less, about 0.7 mm in thickness or less, about 0.5 mm in thickness or less, or about 0.2 mm to about 0.4 mm in thickness. In further or alternative embodiments, high capacities are achieved using such materials in a lithium sulfur battery, e.g., about 1 mAh/cm² to about 20 mAh/cm², about 2 mAh/cm² to about 10 mAh/cm², about 3 mAh/cm² to about 8 mAh/cm², about 5 mAh/cm² to about 7 mAh/cm², about 1 mAh/cm² or more, about 3 mAh/cm² or more, or about 5 mAh/cm² or more. In some instances, sulfur is loaded in at an amount, such as described herein, in g_{sulfur}/cm² and the capacity is as provided herein in an amount of mAh/g_{sulfur}, the product of which thereby provides an area capacity of mAh/cm². In specific instances, such loading achieved using an electrode or electrode material (e.g., substrate thereof) that is about 1 mm in thickness or less, about 0.7 mm in thickness or less, about 0.5 mm in thickness or less, or about 0.2 mm to about 0.4 mm in thickness. In certain embodiments, high sulfur loading is achieved (e.g., relative to the electrode substrate and/or the electrode substrate and interlayer, when taken together), e.g., about 1 mg/cm³ to about 1 g/cm³, about 2 mg/cm³ to about 500 mg/cm³, about 5 mg/cm³ to about 250 mg/cm³, about 10 mg/cm³ to about 100 mg/cm³, about 5 mg/cm³ or more, about 10 mg/cm³ or more, or about 25 mg/cm³ or more. In further or alternative embodiments, high capacities are achieved using such materials in a lithium sulfur battery, e.g., about 1 mAh/cm³ to about 250 mAh/cm³, about 2 mAh/cm³ to about 100 mAh/cm³, about 4 mAh/cm³ to about 80 mAh/cm³, about 5 mAh/cm³ to about 50 mAh/cm³, about 1 mAh/cm³ or more, about 10 mAh/cm³ or more, or about 25 mAh/cm³ or more.

In certain embodiments, provided herein is an electrode or electrode material (or lithium battery comprising the same) having a specific capacity of about 200 mAh/g or more, about 250 mAh/g or more, about 300 mAh/g or more, about 350 mAh/g or more, about 450 mAh/g or more, about 500 mAh/g or more, about 600 mAh/g or more, about 650 mAh/g or more, about 700 mAh/g or more, about 800 mAh/g or more, or about 900 mAh/g or more. In specific embodiments, the capacity is a measured relative to the amount of sulfur present in the electrode (or the overall weight of the electrode). In some embodiments, the capacity is the initial capacity, the capacity after 5 cycles, after 10 cycles, after 20 cycles, after 50 cycles, after 100 cycles, after 200 cycles, after 300 cycles, or more. In some embodiments, the capacity after 5 cycles, after 10 cycles, after 20 cycles, after 50 cycles, after 100 cycles, after 200 cycles, or after 300 cycles is at least 50%, at least 60%, at least 70%, at least 80%, or at least 85% of the initial capacity. Any capacity described herein includes reference to any or all of the charge capacity, discharge capacity, or specific capacity unless otherwise specified. Unless otherwise specified, capacities described herein include reference to any or all of a charge and/or discharge rate of 0.1 C, 0.2 C, 0.25 C, 0.5 C, 1 C, 2 C, 3 C, about 417 mA/g, or more (wherein 1 C is the rate required to completely charge or discharge a cell in 1 hour, 0.5 C is the rate require to completely charge or discharge a cell in 2 hours, etc.).

In specific embodiments, provided herein is an electrode system comprising an electrode substrate (e.g., infused with a sulfur component—thereby forming an electrode, such as a lithium sulfur battery cathode), and a graphenic additive or layer (e.g., configured on the surface thereof, or between the electrode substrate and a counter electrode). In more specific embodiments, the electrode system further comprises an interlayer, such as wherein the graphenic additive or layer is configured between the electrode substrate and the mesoporous interlayer component. In more specific embodiments, the electrode system is configured in a battery cell (e.g., comprising the electrode substrate (e.g., as a cathode) and a counter electrode (e.g., as an anode)). In specific embodiments, a mesoporous (e.g., carbon) interlayer component is configured between a graphenic additive or layer and a separator (e.g., which is configured between interlayer and an anode). In other embodiments, a graphenic component is integrated with a mesoporous interlayer component (e.g., forming a graphenic web, such as that secures the mesoporous interlayer component therewithin). Other configurations are also contemplated, but such configurations generally comprise the graphenic additive/layer and/or mesoporous layer configured between the electrode substrate and the counter electrode. In specific embodiments, a separator is also configured between the electrode substrate and the counter electrode.

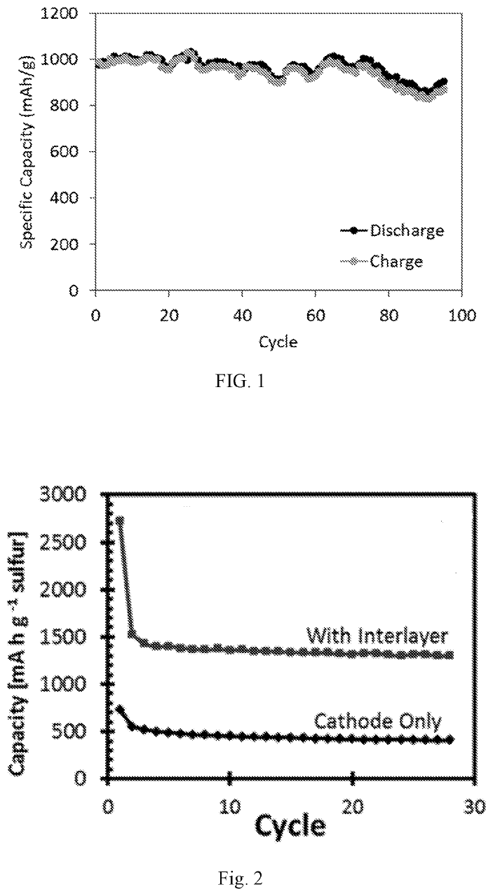

FIG. 1 illustrates the performance of an exemplary lithium sulfur battery provided herein using a conventional lithium sulfur carbon cathode and an interlayer. As is seen, good capacity and retention are demonstrated. For comparison, FIG. 2 illustrates the performance of a carbon black (Super P) and sulfur cathode with and without a mesoporous carbon interlayer. As is illustrated, the presence of the interlayer provides significantly improved capacity and very good capacity retention relative to the battery lacking the interlayer. FIG. 3 illustrates the electrochemical performance of a lithium sulfur coin cell comprising about 4 mg/cm2 of sulfur loaded in an electrode comprising a porous carbon substrate (BC carbon paper substrate) and a conducting carbon substrate component or additive (e.g., a mesoporous conductive carbon, such as Ketjenblack (KB)) with and without a graphenic additive or layer on the surface of the electrode substrate. As is illustrated in FIG. 3, the presence of the graphenic layer improved capacity of the cell by about 200 mAh/g or more. Similarly, FIG. 4 illustrates the benefit of the graphenic add layer compared to an identical cell lacking the graphenic layer. Moreover, FIG. 4 illustrates that additional mesoporous carbon interlayers configured between the electrode and the separator reduce the performance parameters of the cell, particularly the capacity retention.

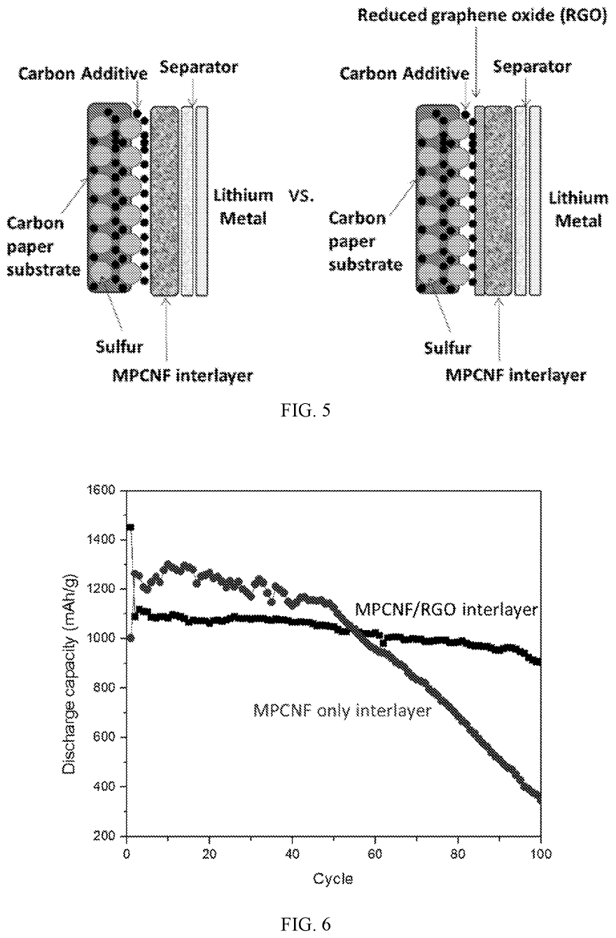

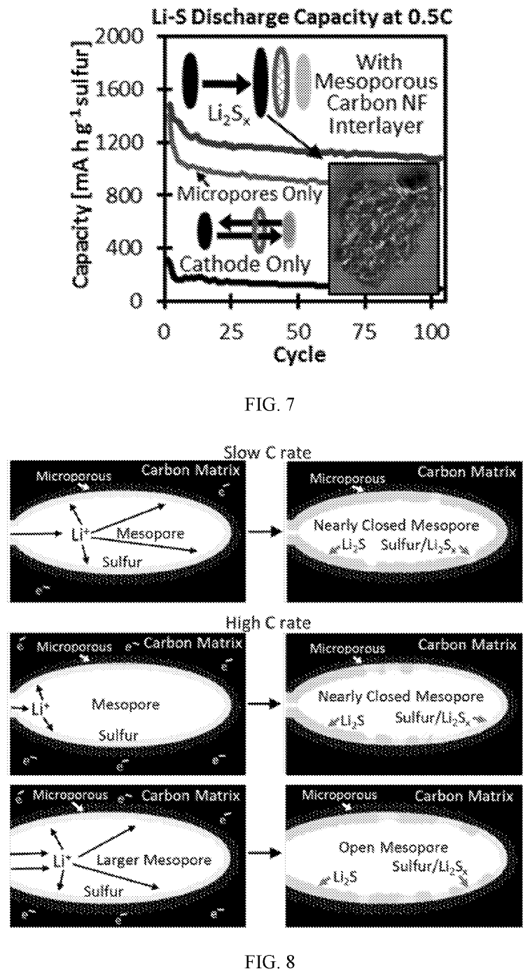

FIG. 5 illustrates exemplary configurations of electrode systems provided herein. In some embodiments, provided herein is an electrode system comprising an electrode substrate (e.g., carbon substrate), an additive (e.g., a conductive and/or carbon additive, such as carbon (e.g., carbon black)) (e.g., the additive embedded within and/or on the surface of the substrate), and an interlayer (e.g., a graphenic and/or mesoporous carbon interlayer, such as comprising mesoporous carbon nanofibers and/or powder/particles). In specific embodiments, the system comprises a graphenic layer or component (e.g., graphene oxide or reduced graphene oxide), such as configured between an electrode substrate and a mesoporous carbon interlayer, such as on the surface of the substrate or interlayer). In certain embodiments, the mesoporous interlayer component and/or graphenic component (e.g., layer or additive) are optionally discrete and/or laminated together and/or with other parts of the battery (e.g., cathode substrate and/or separator). FIG. 6 illustrates cell performance characteristics of exemplary cells having the two configurations illustrated in FIG. 5, with a rate of 0.5 C and sulfur loading of 5 mg/cm². FIG. 7 illustrates exemplary battery performances of electrode systems lacking an interlayer, of a nanofiber interlayer comprising activated carbon (micropores only), and an activated mesoporous carbon nanofiber interlayer (micropores and mesopores). As is illustrated, using otherwise similar systems, the nanofiber interlayer imparts significant performance improvements over the system lacking the interlayer, and the activated mesoporous carbon nanofiber interlayer (mesopores and micropores) imparts significant performance improvements over the system with an activated carbon nanofiber interlayer (micropore only).

In some embodiments, the electrode is thin and/or flexible, facilitating the use of the electrode in numerous applications, including thin layer battery applications, such as for use in wearable electronics. In certain embodiments, an electrode or electrode material provided herein has a thickness of about 0.02 mm to about 2 mm, e.g., about 0.05 mm to about 1 mm, about 0.1 mm to about 0.5 mm, or about 0.2 mm to about 0.4 mm. In certain embodiments, electrodes provided herein (e.g., in a thin layer lithium sulfur battery comprising such an electrode) can be folded at an angle of at least 90 degrees (e.g., at least once, at least twice, at least 5 times, at least 10 times, at least 20 times, at least 50 times, or the like) and retain at least 50% capacity, at least 60% capacity, at least 70% capacity, at least 80% capacity, at least 90% capacity, at least 95% capacity, or at least 98% capacity.

In certain embodiments, the electrode substrate and/or interlayer comprises a three dimensional porous carbon (e.g., a network of carbon nanotubes, carbon paper, a carbon nanofiber mat, or the like), sulfur infused in the porous carbon (e.g., in the case of the electrode), and a carbonaceous or conductive additive. In some embodiments, the carbonaceous or conductive additive is a nanostructured material (e.g., mesoporous carbon nanofibers and/or particles). In certain instances, an additional conductive additive is optionally utilized, such as to facilitate electron conductivity of the substrate and/or electrode as a whole (e.g., to facilitate improved rate capability of the electrode). In specific embodiments, the conductive additive is conductive carbon, such as carbon black (e.g., Super P), carbon nanotubes, graphene nanoribbons, graphene, a graphenic component (such as graphene, reduced graphene oxide, or the like), or any other suitable material. Any suitable amount of carbonaceous or conductive additive is optionally utilized. In specific embodiments, about 0.01 wt. % to about 80 wt. % of carbonaceous and/or conductive additive (relative to the carbon substrate) is optionally utilized. In specific embodiments, about 0.1 wt % to about 50 wt %, about 0.2 wt % to about 40 wt %, about 1 wt % to about 30 wt %, or the like of carbonaceous and/or conductive additive (relative to the carbon substrate) is optionally utilized.

In certain embodiments, an electrode and/or interlayer provided herein comprises a (e.g., three dimensional) mesoporous carbon substrate (e.g., mesoporous carbon powder, mesoporous carbon nanofibers, and/or combinations thereof). In certain embodiments, the mesoporous substrate comprises mesoporous voids (e.g., pores having a dimension (e.g., pore opening, largest dimension, or the like) of between 2 nm and 100 nm. In specific embodiments, the average mesopore size or pore size having the greatest incremental mesopore area is about 5 nm or more, about 10 nm or more, about 15 nm or more, about 20 nm or more, about 25 nm or more, about 30 nm or more, about 50 nm or more, about 10 nm to about 100 nm, about 20 nm to about 80 nm, about 25 nm to about 50 nm, or the like. In preferred embodiments, larger mesopores are desired to facilitate lithiation and delithiation of active cathode materials (sulfur component) during battery operation. In certain embodiments, the mesopore size (e.g., of the pores having a size between 2 nm and 50 nm, or 2 nm and 100 nm) of the mesoporous carbon (nanofibers and/or powder) contributing the greatest area to the mesoporous carbon is at least 5 nm, such as at least 10 nm, at least 15 nm, at least 20 nm, at least 25 nm, or at least 50 nm (e.g., up to 25 nm, up to 50 nm, or up to 100 nm) (e.g., based on the maximum dimension of the pore). In some embodiments, the maximum incremental mesopore area (e.g., the collective area of all of the mesopores of the mesoporous carbon having a particular pore size) of the mesoporous carbon is achieved for mesopores (e.g., of the pores having a size between 2 nm and 50 nm, 3 nm and 50 nm, or 2 nm and 100 nm) having mesopore size of at least 5 nm, such as at least 10 nm, at least 15 nm, at least 20 nm, at least 25 nm, or at least 50 nm (e.g., up to 25 nm, up to 50 nm, or up to 100 nm) (e.g., based on the maximum dimension of the pore).

In some instances, the maximum incremental pore area of a mesoporous structure (e.g., 2-100 nm, such as 2-50 nm or 3-50 nm) of a material provided herein is at least 2 m²/g, such as at least 4 m²/g, or at least 5 m²/g or at least 6 m²/g. In certain instances, the maximum incremental pore volume of a mesoporous structure (e.g., 2-100 nm, such as 2-50 nm or 3-50 nm) of a material provided herein is at least 0.02 cm³/g, such as at least 0.03 cm³/g, or at least 0.04 cm³/g, or at least 0.05 cm³/g.

FIG. 8 illustrates a schematic of small vs. large mesopores and the effect, in some instances, of the charging rate. As is illustrated, in some instances, at both slow and fast charge rates, smaller pores can become blocked by the expanding sulfur component during lithiation. At faster rates, however, the pore closes more quickly, restricting access to the active cathode material within the pore. With larger pores, however, lithium can more readily enter the pore and access the active sulfur material, at both slow and high rates, even as lithiation of the active material occurs.

Provided in certain embodiments herein are materials incorporating mesoporous carbon, such as mesoporous carbon nanofiber described herein. In some instances, also provided herein is such mesoporous carbon, as well as processes for manufacturing the same. In particular, mesoporous carbon (e.g., nanofibers, such having aspect ratios over 10 or over 100, or particles having aspect ratios below 100, such as 1 to about 10) provided herein have large mesopores and/or high surface areas. In some instances, conventional mesoporous carbon has small mesoporous structures (close to microstructure sizes), such as below 5 micron. As illustrated in FIG. 8, such pore sizes can contribute, in some instances—particularly with high sulfur loading, poor cell performance due to an inability to access active electrode materials.

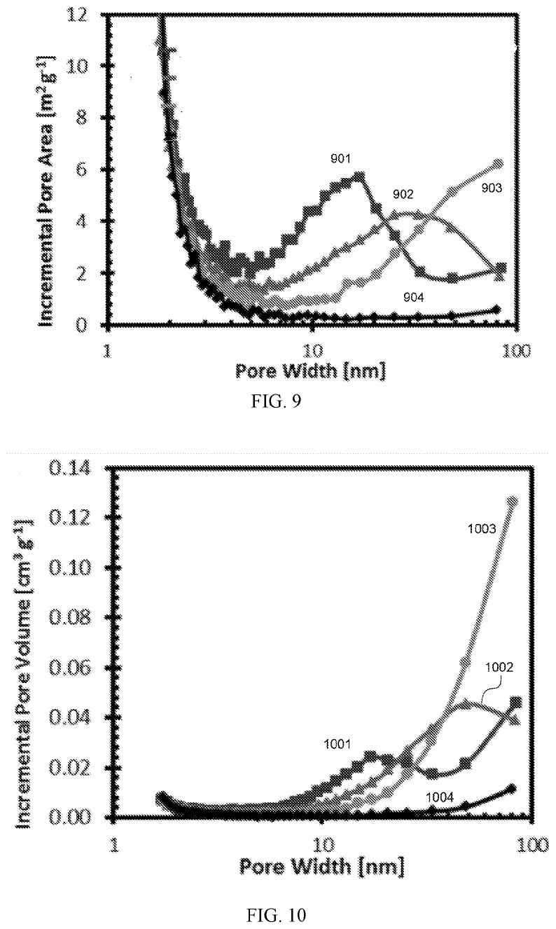

In certain instances, mesopores having a size of at least 5 nm have the greatest incremental pore area (relative to other mesopore sizes). In general, the incremental pore area is the surface area of the material contributed by mesopores of a given size. Moreover, in general, mesopores are considered to be pores that having an average or largest dimension of 2 nm to 100 nm, such as 2 nm to 50 nm, or 3 nm to 50 nm (with structures below 2 nm being micropores, which can be added on the surface of the carbon in and outside of the mesoporous structures using activation processes described herein, such as thermal treatment). FIG. 9 and FIG. 10 illustrate pore sizes of various materials provided herein. In some instances, mesopores having a size of at least 10 nm have the greatest incremental pore area (relative to other mesopore sizes). In some instances, mesopores having a size of at least 15 nm, at least 20 nm, at least 25 nm, or the like have the greatest incremental pore area (relative to other mesopore sizes). In some embodiments, mesopores of the mesoporous carbon (nanofibers and/or powder) contributing the greatest area to the mesoporous carbon is at least 5 nm, such as at least 10 nm, at least 15 nm, at least 20 nm, at least 25 nm, or at least 50 nm (e.g., up to 25 nm, up to 50 nm, or up to 100 nm) (e.g., based on the maximum dimension of the pore). In some embodiments, the maximum incremental mesopore area (e.g., the collective area of all of the mesopores of the mesoporous carbon having a particular pore size) of the mesoporous carbon is achieved for mesopores (e.g., of the pores having a size between 2 nm and 50 nm, 3 nm and 50 nm, or 2 nm and 100 nm) having mesopore size of at least 5 nm, such as at least 10 nm, at least 15 nm, at least 20 nm, at least 25 nm, or at least 50 nm (e.g., up to 25 nm, up to 50 nm, or up to 100 nm) (e.g., based on the maximum dimension of the pore). In some embodiments, the average mesopore size of the mesoporous carbon is at least 5 nm, at least 7 nm, at least 10 nm, at least 15 nm, at least 20 nm, or the like.

Also provided herein are processes for varying the pore characteristics of mesoporous carbon provided herein. As illustrated in FIG. 9 and FIG. 10, the instant disclosure provides for varying overall surface area of mesoporous carbon, as well as the size of the mesopores in mesoporous carbon. As demonstrated, the instant disclosure provides processes for producing mesoporous carbon with high surface area and large mesoporous structures. FIG. 9 illustrates characteristics of various mesoporous carbon nanofibers provided and/or prepared according to processes and/or used in compositions described herein. As illustrated, carbon nanofibers derived from PAN (electrospin at 30% RH) provide a microporous nanofiber structure, with a surface area (BET) of about 650 m²/g, and a micropore fraction of the surface area of about 85%. By contrast, using a polymer blend (e.g., pyrolyzing polymer and sacrificial polymer blend, such as PAN/CDA or PAN/PMMA), mesoporous carbon nanofibers are prepared, with mesoporous size distribution being well tuned by controlling the relative humidity (RH) used during gas-assisted electrospinning (e.g., followed by thermal pyrolysis of pyrolyzing polymer and removal of sacrificial polymer) of similar polymer nanofiber materials. At low relative humidity smaller mesopores are observed, with larger mesopores observed when using a higher relative humidity. In some embodiments, the mesoporous carbon has high surface area with a relatively small micropore fraction of the surface area (e.g., due to the increased mesoporous contribution to the surface area). In specific embodiments, the mesoporous carbon provided herein has a surface area (BET) of greater than 650 m²/g (e.g., at least 655 m²/g) and a micropore fraction of the surface area of less than 85% (e.g., less than 82%).

In certain instances, surface areas provided herein are determined using any suitable technique, such as using Brunauer-Emmet-Teller (BET) techniques.

FIG. 10 illustrates characteristics of various mesoporous carbon nanofibers prepared according to processes and/or used in compositions described herein. As illustrated, carbon nanofibers derived from PAN (electrospin at 30% RH) provide very little mesoporous pore volume. By contrast, using a polymer blend (e.g., pyrolyzing polymer and sacrificial polymer blend, such as PAN/CDA or PAN/PMMA), mesoporous carbon nanofibers are prepared, with mesoporous pore size distributions being well tuned by controlling the relative humidity (RH) used during gas-assisted electrospinning (e.g., followed by thermal pyrolysis of pyrolyzing polymer and removal of sacrificial polymer) of similar polymer nanofiber materials. At low relative humidity, smaller mesopores are observed, with larger mesopores observed when using a higher relative humidity. In some embodiments, the maximum mesopore (e.g., pores having size of 2-50 nm or 2-100 nm) volume of mesoporous carbon material provided herein is provided by pores that have a size of at least 10 nm, at least 15 nm, at least 20 nm, at least 25 nm, at least 30 nm, about 50 nm, or the like.

In certain embodiments, any mesoporous material provided herein has an (e.g., maximum) incremental pore area in the 2-50 nm and/or 2-100 nm, such as in the 5-50 nm or 5-100 nm, or 10-50 nm or 10-100 nm, range of at least 2 m²/g, at least 4 m²/g, or the like. Pore size vs. area distributions of exemplary mesoporous materials (mesoporous carbon nanofibers) are illustrated in FIG. 9 for the PAN/CDA materials and exemplary microporous materials are illustrated in FIG. 9 for the PAN only materials. In certain embodiments, a mesoporous material provided herein has an (e.g., average or number maximum (on a volume distribution curve such as illustrated IN FIG. 10)) incremental pore volume in the 2-50 nm and/or 2-100 nm range of at least 0.01 m³/g, at least 0.02 m³/g, at least 0.03 m³/g, at least 0.04 m³/g, or the like. Pore size vs. volume distributions of exemplary mesoporous materials (mesoporous carbon nanofibers) are illustrated in FIG. 10 for the PAN/CDA materials and exemplary microporous materials are illustrated in FIG. 10 for the PAN only materials.

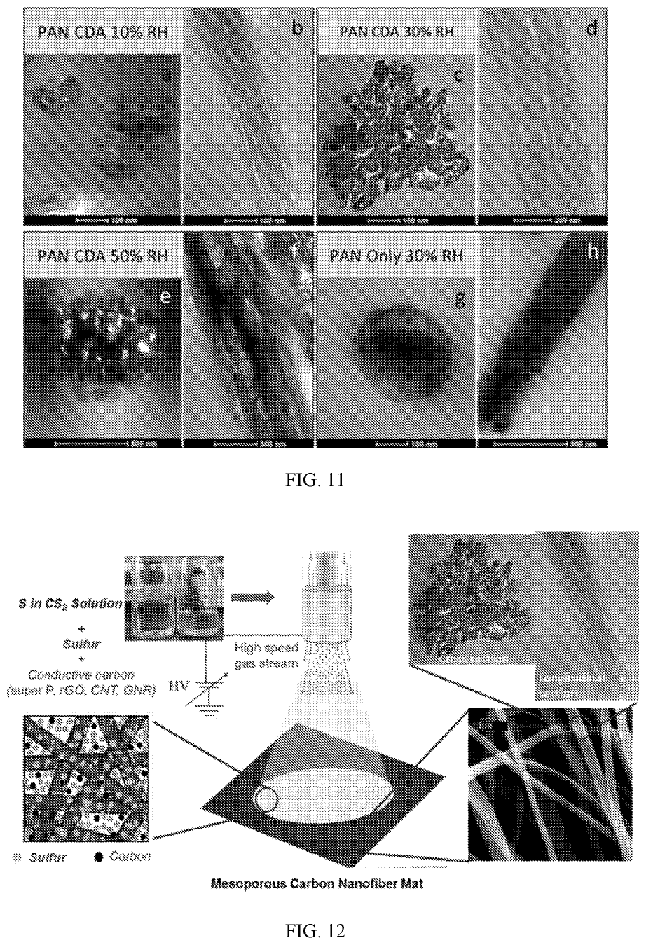

FIG. 11 illustrates TEM images of various (cross and lateral sectionally microtomed) mesoporous carbon nanofibers prepared by electrospinning and pyrolyzing polymer blends (e.g., PAN/CDA) at various relative humidities and a microporous carbon fiber similarly prepared from a mono-polymer (PAN), as discussed above.

In some embodiments, provided herein is a coated battery separator, or a battery separator laminate. In specific embodiments, the coated battery separator or battery separator laminate comprises a porous polymer (e.g., a polyolefin film, such as polyethylene or polypropylene) membrane or film or a porous polymer-ceramic (hybrid or composite) membrane or film.

In certain embodiments, the battery separator comprises a nanofiber mat, the nanofiber mat comprising one or more nanofiber comprising polymer. In more specific embodiments, the one or more nanofiber further comprises ceramic. In certain embodiments, the one or more nanofiber comprises a polymer matrix core, such as a continuous polymer matrix core. In specific embodiments, the polymer matrix core is co-continuous with ceramic. In some embodiments, some or all of the one or more nanofibers of any separator herein separator comprise are at least partially coated or shelled with a continuous ceramic (e.g., covering at least 30%, at least 50%, at least 70%, at least 90%, or the like of one or more surface thereof). In some embodiments, the battery separator comprises a film or membrane, such as comprising a (e.g., continuous) ceramic coating or shell (e.g., covering at least 30%, at least 50%, at least 70%, at least 90%, or the like of one or more surface thereof). In some instances, a film is or comprises a continuous, non-fibrous porous material. In certain instances, a membrane comprises a porous nanofiber mat, such as described herein. Exemplary polymer-ceramic hybrid membranes and films are as described in International Patent Application No. PCT/US18/33020, entitled “Hybrid Separators and the Manufacture Thereof,” filed May 16, 2018, which is hereby incorporated herein by reference for such disclosure.

In some embodiments, the coated separator or separator laminate comprises a first layer, being a separator (e.g., porous membrane, such as comprising polymer or polymer and ceramic), such as described herein and further comprising a second layer, such as a coating or film. In specific embodiments, the second coating, layer or film comprising (a) mesoporous carbon, (b) a graphenic component, (c) a second polymer, or (d) any combination thereof. In specific embodiments, the second layer (such as a coating or film) comprises an interlayer as described herein. In some embodiments, the second layer comprises mesoporous carbon, such as mesoporous carbon nanofibers, mesoporous carbon particles, or a combination thereof.

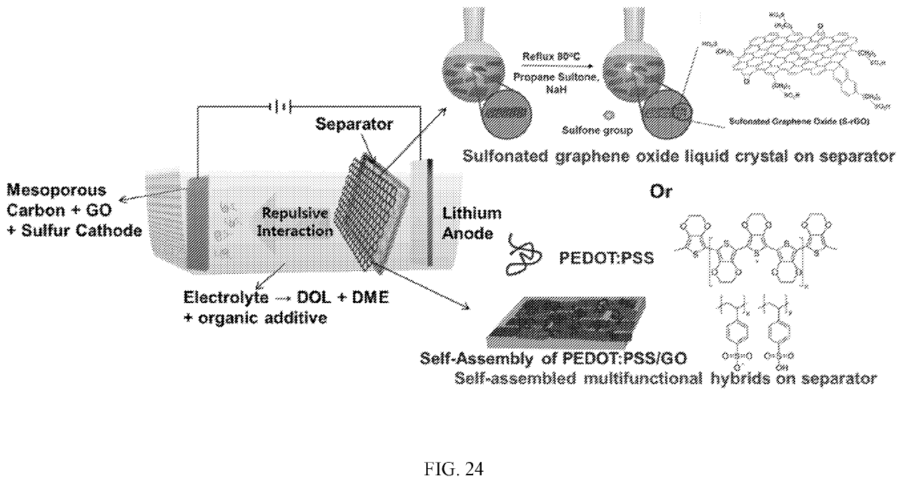

In specific preferred embodiments, the second layer comprises a graphenic component (e.g., graphene, reduced graphene oxide, graphene oxide, a functionalized graphene, or a combination thereof). In some preferred specific embodiments, the second layer comprises a second polymer (e.g., a conducting polymer). FIG. 24 illustrates an exemplary battery configuration comprising separator laminate comprising a porous polymer film and exemplary secondary layers (e.g., a sulfonated graphene oxide and/or PEDOT and/or PSS). In certain embodiments, the laminate or coated separator is prepared by providing the porous polymer or polymer-ceramic (e.g., porous) film, dissolving and/or suspending (or otherwise dispersing) the secondary material in a fluid stock and electrospraying the fluid stock, thereby depositing the secondary material on a surface of the (separator) film or membrane. In some instances, functional (e.g., ionic shielding) groups, such as sulfone offer repulsive interaction against polysulfides, leading to more effective confinement of polysulfides in the cathode side. In some instances, polymer (such as PEDOT:PSS) offers conductivity and/or binding to the separator when a graphenic component is utilized in combination with the second polymer (polymer of the separator being the first polymer of the coated or laminated separator). In certain instances, use of polymer and/or graphenic component in the second layer (or in an interlayer described herein) facilitates sulfur retention at the cathode, allowing reduction of the interlayer mass, such as down to about 50 wt. % or less of the cathode substrate, such as down to about 30 wt. % or less, such as about 25 wt. % of the cathode substrate. Moreover, in some instances, even with such thin interlayer materials, the sulfur loading is very high, such as about 5 mg/cm² or more (e.g., about 6 mg/cm² or more, about 5 mg/cm² to about 10 mg/cm², or the like), while retaining good performance parameters (capacity, capacity retention, and/or the like), such as provided herein.

In some embodiments, the ceramic coating of a separator or separator material (e.g., nanofiber thereof) is a continuous coating (e.g., comprising a two-dimensional matrix running without interruption or break along and/or on the surface of the separator membrane or film or nanofibers thereof, such as opposed to a plurality of ceramic particles which would be a plurality of zero dimensional ceramic materials having a non-continuous, interrupted/broken matrix). In certain embodiments herein, a separator membrane, film, fiber or porous material comprising a polymer material or matrix and having a surface thereof has at least a portion of the surface coated with ceramic (e.g., a non-particulate based and/or two-dimensional and/or continuous ceramic coating). In specific embodiments, at least 20% of the surface is coated with ceramic. In more specific embodiments, at least 40% of the surface is coated with ceramic. In still more specific embodiments, at least 60% of the surface is coated with ceramic. In yet more specific embodiments, at least 80% of the surface is coated with ceramic. In more specific embodiments, at least 90% of the surface is coated with ceramic. In still more specific embodiments, at least 95%, at least 98%, or at least 99% of the surface is coated with ceramic.

In some embodiments, a battery cell provided herein comprises a first electrode comprising an electrode substrate component (e.g., comprising mesoporous carbon and a carbon and/or conducting additive, such as carbon black or mesoporous carbon particles, such as KB) and a sulfur component, an additive (e.g., graphenic) layer, and a second electrode, the additive layer being configured between the first electrode and the second electrode. In further embodiments, the battery cell further comprises a separator configured between the first and second electrodes. In specific embodiments, the additive layer is configured between the first electrode and the separator.

Provided in certain embodiments herein are lithium batteries (e.g., lithium sulfur batteries) comprising an electrode described herein. In some embodiments, the lithium battery comprises a negative electrode, a separator, and a positive electrode, the positive electrode being an electrode described herein. Generally, the separator is positioned between the positive and negative electrodes. Any suitable separator, such as a coated separator described herein, is optionally utilized. In certain embodiments, the battery comprises an interlayer (e.g., a discrete body, or coated on a positive electrode or separator thereof).

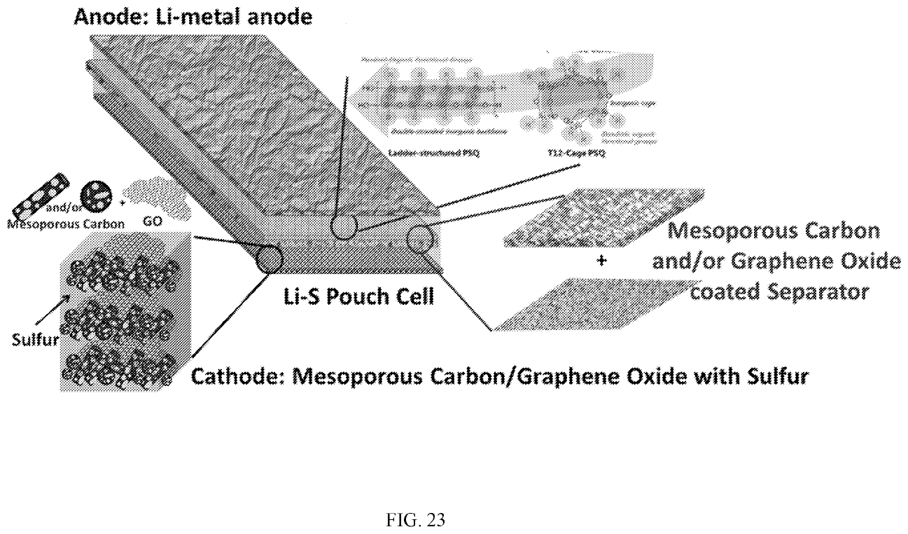

In certain embodiments, a battery provided herein comprises an electrolyte. Any suitable electrolyte and/or separator is optionally utilized in a cell or battery provided herein. In certain embodiments, the electrolyte is a liquid electrolyte. In other embodiments, the electrolyte is a solid, semi-solid, or gel electrolyte (or otherwise ionic conductive solid). Exemplary semi-solid or gel electrolytes optionally utilized are set forth in U.S. Patent Application No. 62/506,980, entitled “Gel Electrolytes and the Manufacture Thereof,” filed on 16 May 2017, which is incorporated herein in its entirety. FIG. 23 illustrates an exemplary battery configuration provided herein utilizing such an electrolyte system.

In some embodiments, the electrolyte comprises a non-aqueous, e.g., an aprotic, solvent. In specific embodiments, the electrolyte comprises a non-aqueous, e.g., aprotic, solvent and a lithium salt (e.g., LiCF₃SO₄ and LiNO₃). In specific embodiments, the lithium salt is, by way of non-limiting example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, LiCH₃SO₃, LiCF₃SO₃, a lithium carbonate (lower aliphatic carbonate), or the like, or a combination thereof. Recitation of such a salt in a solvent herein, includes such salt being in solvated, disassociated, partially disassociated, and/or associated forms. In various embodiments, non-aqueous solvents include, by way of non-limiting example, cyclic carbonic acid esters (e.g., ethylene carbonate or propylene carbonate), acyclic carbonic acid esters (e.g., dimethylcarbonate, ethyl methyl carbonate, or diethyl carbonate), cyclic carboxylic acid esters (e.g., y-butyrolactone), cyclic ethers (e.g., tetrahydrofuran, 2-methyltetrahydrofuran, or dioxolane), acyclic ethers (e.g., dimethoxymethane or dimethoxyethane), and combinations thereof. Suitable aprotic solvents include, by way of non-limiting example, 1,2-dimethoxyethane (DME), dioxolane (DOL), or a combination thereof.

In certain embodiments, the separator comprises a polymeric material, such as a porous polymer matrix. In some embodiments, the separator polymer is a polyolefin (e.g., polypropylene (PP), polyethylene (PE)), polyethylene terephthalate (PET), polyphenylene sulfide (PPS), polyvinylidene fluoride (PVdF), polymethylmethacrylate (PMMA), polyacrylonitrile (PAN), polyvinlacetate (PVAC), or the like. In specific embodiments, the separator comprises a porous polymer (e.g., polyethylene (PE) or polypropylene (PP)) film, such as manufactured by Celgard® (stretched or cast polymer films). In other embodiments, the separator comprises a nanofiber mat. In specific embodiments, the nanofiber mat comprises one or more nanofiber comprising a polymer. In some specific embodiments, the nanofibers comprise a polymer matrix. In more specific embodiments, the nanofiber(s) comprise a polymer matrix with nanoclay or ceramic nanostructures (e.g., nanoparticles) embedded within the polymer matrix (e.g., wherein the nanostructures are not agglomerated). Any suitable clay or ceramic is optionally utilized, e.g., silica, alumina, zirconia, beryllia, ceria, titania, barium titanate, strontium titanate, montmorillonite, fluorohectorite clay, laponite clay, bentonite, beidellite, hectorite, saponite, nontronite, sauconite, vermiculite, ledikite, magadiite, kenyaite, stevensite, or a combination thereof. In other embodiments, the nanofibers comprise a polymer matrix and a ceramic (e.g., silica) matrix. In specific embodiments, suitable polymer/clay and polymer/ceramic nanostructures and methods for manufacturing the same are described in more detail in U.S. Pat. No. 7,083,854, PCT/US13/066056, and WO 2015/084951, each of which are incorporated herein for such disclosure. In certain embodiments, a polymer membrane or polymer-ceramic hybrid membrane is utilized as a separator herein.

The separator is of any suitable thickness and porosity. In some embodiments, the thickness is about 5 microns to about 50 microns. In specific embodiments, the thickness is about 8 microns to about 40 microns. In still more specific embodiments, the thickness is about 10 microns to about 35 microns. In some embodiments, the porosity of the separator is about 30% to about 70%, or about 35% to 60% (e.g., as determined by the void space as a percentage of the total apparent volume of the separator material).

In addition, any suitable negative electrode is optionally utilized. In certain embodiments, the negative electrode comprises lithium metal (e.g., a lithium metal foil), and/or lithiated silicon (e.g., lithiated silicon (e.g., micro- (e.g., having a or an average dimension of greater than 500 nm) or nano- (e.g., having a or an average dimension of less than 2 micron)) particles, including low aspect ratio particles (e.g., aspect ratio of about 1 to about 10) and high aspect ratio particles (e.g., aspect ratio of greater than 10, including fibers, rods, pillars, and the like). In certain instances, a negative electrode provided herein comprises lithium metal, silicon, germanium, tin, oxides thereof, or combinations thereof.

In specific embodiments, the negative electrode comprises lithium, such as a lithium sheet (e.g., foil). In more specific embodiments, the negative electrode comprises lithium, such as a lithium sheet (e.g., foil), in combination with a conductive metal (e.g., aluminum or copper), such as a conductive metal sheet (e.g., foil). In certain embodiments, the negative electrode comprises a lithium deposition. In some embodiments, the negative electrode comprises nanostructured lithium.

In further or alternative embodiments, the negative electrode comprises silicon, germanium, or tin, or oxides thereof, such as nanoparticles thereof.

The battery of any one of the preceding claims, wherein the negative electrode comprises a plurality of nanostructures (e.g., nanoparticles), the nanostructures comprising silicon, germanium, tin, an oxide thereof, or a combination thereof. In certain embodiments, the nanostructures comprise a composite of carbon and silicon, germanium, tin, an oxide thereof, or a combination thereof. In certain embodiments, nanostructures comprise nanofibers, or fragments thereof, comprising nanoparticles of silicon, germanium, tin, oxides thereof, or a combination thereof, embedded within carbon. In some embodiments, the negative electrode comprises a silicon-carbon nanocomposite nanofiber, the nanofiber comprising a plurality of (e.g., non-aggregated) silicon nanoparticles embedded in a carbon matrix. In further or alternative embodiments, the negative electrode comprises a silicon-carbon nanocomposite, the nanocomposite comprising a plurality of (e.g., non-aggregated) silicon nanoparticles wrapped with carbon. In some embodiments, specific silicon-carbon nanocomposite materials and processes for manufacturing the same are described in more detail in WO 2013/130712 and PCT/US14/025974, both of which are incorporated herein by reference for such disclosure.

The battery of any one of the preceding claims, wherein the negative electrode further comprises carbon, such as a carbon allotrope. In certain embodiments, the carbon additive is a nanostructured carbon. In specific embodiments, the negative electrode comprises carbon powder, carbon nanotubes, graphene (e.g., graphene sheets, graphene nanoribbons, or a combination thereof), or a combination thereof.

In certain embodiments, provided herein is a battery comprising any one or more of the components described herein, and a battery housing enclosing such components. In some embodiments, the battery comprises a positive electrode described herein. In some embodiments, the battery comprises a sulfur-containing positive electrode (e.g., integrated with a porous carbon substrate that functions alone or in combination (e.g., with conductive additives) as a current collector), a negative electrode (e.g., a lithium metal negative electrode), and a conductive metal (e.g., aluminum or copper) negative electrode current collector. In further embodiments, the battery further comprises a positive electrode current collector (e.g., a conductive metal, such as aluminum or copper).

In specific embodiments, the battery provided herein is a flexible battery. In more specific embodiments, the battery provided herein is a flexible thin film battery. In other specific embodiments, the battery is a flexible thin wire battery. In certain embodiments, a battery provided herein comprises a flexible battery housing. In specific embodiments, the housing encloses the battery components described herein. Generally, the battery housing comprises an inert material. In specific embodiments, the flexible battery body comprises a thin sheet (film) of an inert, flexible polymer. In some embodiments, the housing comprises a polyolefin, such as high density polyethylene (HDPE), polyethylene (PE) or polypropylene (PP), polyethylene terephthalate (PET), polyamide, polyurethane, vinyl acetate, nylon (e.g., 6,6-nylon), copolymers thereof, or combinations thereof (e.g., multi-layered constructs). In more specific embodiments, the inert, flexible polymer is polydimethylsiloxane (PDMS).

In some embodiments, the flexible battery body has a first dimension (e.g., the longest dimension—length) and a second dimension (e.g., the shortest dimension, such as height/width/thickness), wherein the ratio of the first dimension to the second dimension is at least 10. In more specific embodiments, the ratio is at least 20. In still more specific embodiments, the ratio is at least 50 or at least 100.

Also provided herein are processes of manufacturing electrodes, electrode systems, separator systems, and component parts thereof. In addition, provided herein are processes of manufacturing mesoporous (e.g., large pore mesoporous) carbon nanofibers. In some embodiments, a fluid composition (e.g., charged fluid composition) comprising an additive is injected into a gas stream to produce one or more material provided herein, or precursor thereof.

In specific embodiments, provided herein is a process of preparing an electrode substrate or electrode, or material thereof, such as described herein, the process comprising:
a. providing a fluid stock, the fluid stock comprising mesoporous carbon (e.g., mesoporous carbon particles and/or nanofibers) and, in some instances, a graphenic component (e.g., graphene oxide, reduced graphene oxide, graphene, or a combination thereof);
b. providing a collector (e.g., a current collector, such as a metal foil);
c. applying an electrical charge or voltage to the fluid stock (e.g., thereby forming a charged fluid stock);
d. injecting (or otherwise ejecting from a nozzle, such as an electrospray nozzle) the fluid stock (e.g., charged fluid stock) into or with a stream of gas (e.g., thereby forming an aerosol or plume); and
e. collecting a mesoporous carbon deposition or film on the collector.

FIG. 19 illustrates an exemplary schematic of an embodiment of such a process.

In specific embodiments, the mesoporous carbon is or comprises mesoporous carbon nanofibers. In some embodiments, the mesoporous carbon is or comprises mesoporous carbon particles. In specific embodiments, the mesoporous carbon comprises mesoporous carbon nanofibers (e.g., having an aspect ratio of at least 50, at least 100, at least 500, or the like) and mesoporous carbon particles (e.g., having an average aspect ratio of less than 100, less than 10, less than 5, or the like). In various embodiments, mesoporous carbon utilized in such processes is described herein, such as described in the electrode (e.g., cathode) materials described herein.

In specific embodiments, the graphenic component is included in the fluid stock. In some instances, the deposition or film collected comprises a graphenic web with mesoporous carbon embedded therein (e.g., within graphenic pockets defined by the graphenic web). In certain instances, the deposition or film collected comprises a bulk material (or body of the deposition or film), the bulk material comprising graphenic component embedded therein, such as described for the electrode (e.g., cathode) described herein. In some instances, graphenic material is configured on the surface of the bulk of the film or deposition.

In some embodiments, particularly wherein a graphenic component is included in the fluid stock, the process further comprises thermally and/or chemically reducing the mesoporous carbon deposition (e.g., to at least partially reduce the graphenic component from a graphene oxide to a reduced graphene oxide).

In certain embodiments, to prepare an electrode, such as described herein, the process further comprises infusing the mesoporous carbon deposition or film with a sulfur component. Infusion of the sulfur component into the mesoporous carbon deposition is achieved using any suitable mechanism, such as through depositing or casting a sulfur component solution or mixture onto the deposition or film. In preferred embodiments, a second fluid stock comprising the sulfur component (e.g., sulfur) and a fluid (e.g., carbon disulfide) is provided, a second electrical charge or voltage is applied thereto (e.g., thereby producing an aerosol or plume which is collected on the deposition or film). In more preferred embodiments, the second fluid stock (e.g., second charged fluid stock) is injected into a gas stream, such as to produce a fine aerosol or plume to facilitate uniform deposition of the sulfur component on and into the deposition or film.

Also provided herein are processes of manufacturing (e.g., by electrospinning techniques described herein, such as gas-assisted electrospinning) mesoporous nanofibers, such as for use in electrode substrates and/or interlayer materials. In specific embodiments, such a process comprises:
a. mixing a first polymer with a second polymer, forming a liquid polymer mixture (e.g., neat or in solution);
b. applying a voltage or an electrical charge to the liquid polymer mixture (e.g., forming a charged liquid polymer mixture);
c. injecting the charged liquid polymer mixture into a stream of gas; and
d. thermally treating (e.g., pyrolyzing) one or more resultant nanofiber (e.g., carbonizing the first polymer and removing the second polymer), forming one or more mesoporous carbon nanofiber.

In certain embodiments, the second polymer is a sacrificial polymer, which is removed upon thermal treatment (e.g., less than 20 wt. % remains (e.g., as carbon), less than 10 wt. % remains, less than 5 wt. % remains after thermal treatment). In some embodiments, the first polymer is a polymer that is carbonized after thermal treatment (e.g., at least 20 wt. % remains (e.g., as carbon), at least 30 wt. % remains, at least 40 wt. % remains, at least 50 wt. % remains, or the like after thermal treatment.

In specific embodiments, the first and second polymers are not miscible with one another, such as forming separate domains during processing (e.g., electrospinning). In some embodiments, the second polymer forms discrete domains within a matrix of the first domain during processing (e.g., electrospinning, such as gas-assisted electrospinning).

In some embodiments, the first polymer is polyacrylonitrile (PAN), polyvinylacetate (PVA), polyvinylpyrrolidone (PVP), a cellulose (e.g., cellulose), a polyalkylene (e.g., ultra-high molecular weight polyethylene (UHMWPE)), or the like. In certain embodiments, the first polymer is styrene-co-acrylonitrile (SAN), or m-aramid. In certain embodiments, the second (e.g., sacrificial) polymer is a polyalkyleneoxide (e.g., PEO), polyvinylacetate (PVA), a cellulose (e.g., cellulose acetate, cellulose diacetate, cellulose triacetate, cellulose), nafion, polyvinylpyrrolidone (PVP), acrylonitrile butadiene styrene (ABS), polycarbonate, a polyacrylate or polyalkylalkacrylate (e.g., polymethylmethacrylate (PMMA)), polyethylene terephthalate (PET), nylon, polyphenylene sulfide (PPS), or the like. In some embodiments, the second polymer is styrene-co-acrylonitrile (SAN), polystyrene, a polymimide or an aramid (e.g., m-aramid). In specific embodiments, the second polymer is a cellulose, a polyimide or an aramid. Generally, the first and second polymers are different. In preferred embodiments, the first polymer is polyacrylonitrile (PAN) and the second polymer is cellulose diacetate (CDA) and/or polymethymethacrylate (PMMA). However, any suitable polymers are optionally utilized, such as described in WO 2015/027052, entitled “Porous Carbon Nanofibers and Manufacturing Thereof,” which is incorporated herein by reference in its entirety.

In specific embodiments, the first polymer and second polymer are mixed with a solvent to form the liquid polymer mixture, such as as a polymer solution. Any suitable concentration is optionally utilized. In gas-assisted processes provided herein, high loading of polymer in the solution is possible, with liquid polymer mixture vscosities of at least 50 cP, at least 100 cP, at least 250 cP, at least 500 cP, at least 1,000 cP, or more being utilized.

In some embodiments, the liquid polymer mixture is injected into one or more gas stream at a direction that is within about 15 degrees of the direction of the one or more gas stream. In specific embodiments, the liquid polymer mixture is injected into one or more gas stream at a direction that is within about 10 degrees of the direction of the one or more gas stream. In more specific embodiments, the liquid polymer mixture is injected into one or more gas stream at a direction that is within about 5 degrees of the direction of the one or more gas stream.

In certain embodiments, humidity control of the atmosphere into which the polymer mixture is injected facilitates control of the mesopore size distributions of the mesoporous carbon nanofibers described herein. For example, as illustrated in the examples and figures herein, in some instances, lower relative humidity produce smaller pore sizes, whereas large relative humidity produce larger pore sizes. As discussed herein, in some instances, larger mesopore sizes facilitate improved performance parameters, such as when used in a cathode substrate material herein. In some embodiments, the relative humidity (RH) of a gas stream and/or ambient atmosphere into which a polymer mixture is injected is about 10% or more. In specific embodiments, the relative humidity is about 30% or more, such as about 30% to about 50%. In more specific embodiments, the relative humidity is about 50% or more. As illustrated and demonstrated, such as in FIG. 9, FIG. 10, and FIG. 11, in some instances, control of the relative humidity of the air into which the fluid stock is injected facilitates control of the types and sizes of sacrificial domains and/or mesoporous structures formed during manufacturing. In turn, in some instances, control of mesoporous structures present in the mesoporous carbon structures facilitates the ability to control and improve performance parameters of lithium sulfur positive electrode systems comprising such mesoporous materials (e.g., mesoporous electrode substrate and/or mesoporous interlayer components), such as exemplarily illustrated in FIG. 16 and FIG. 22.

In certain embodiments, a process herein further comprises activating the mesoporous carbon provided herein, such as by a thermal treatment described herein.

In certain embodiments, wherein an interlayer is prepared, the process further comprises assembling the one or more mesoporous carbon nanofiber into a battery interlayer. In some embodiments, the collected mesoporous carbon nanofiber is collected as a nanofiber mat and assembled into an interlayer material, such as by cropping and/or compressing the mat. In certain embodiments, additional components are deposited on the nanofiber mat, such as by electrospray techniques, including gas-assisted electrospray techniques described herein. In certain embodiments, collected mesoporous carbon nanofibers are collected and deposited (e.g., by electrospray (e.g., using a gas-assisted electrospray technique described herein)) onto an electrode and/or separator described herein. In some embodiments, the collected mesoporous carbon nanofibers are chopped or otherwise broken up prior to processing. In some embodiments, the mesoporous carbon nanofibers are deposited concurrently or sequentially with mesoporous carbon powder and/or a graphenic component.

Also provided herein are methods of preparing electrode systems and batteries comprising the same (e.g., lithium sulfur batteries). In specific embodiments, a battery or electrode system is prepared by: (a) providing an electrode substrate (e.g., comprising mesoporous carbon (e.g., and an additive, such as a conducting and/or carbon additive, and/or a graphenic component), such as prepared according to a process described herein); and (b) configuring an interlayer (e.g., comprising mesoporous carbon) in proximity to a surface of the electrode substrate (e.g., wherein the interlayer covers at least one surface of the electrode substrate), such as between the electrode substrate and a battery separator.

In some embodiments, the electrode substrate is infused with a sulfur component prior to configuring the interlayer in proximity to the electrode substrate, or the process further comprises a step of infusing the substrate with a sulfur component, such as using a deposition, casting, or electrospray process described herein for infusing a substrate with a sulfur component.

In some embodiments, the interlayer comprises a (e.g., compressed) mesoporous carbon nanofiber mat component that is configured (e.g., as a discrete layer) in proximity to the electrode substrate, such as between the electrode substrate and a battery separator. In certain embodiments, the interlayer (or component parts thereof, such as an ionic shielding layer, graphenic layer, and/or mesoporous carbon layer) is coated on or otherwise forms a laminate (e.g., is affixed to) with the electrode substrate and/or separator.

In certain embodiments, the interlayer further comprises a graphenic or ionic shielding component. In specific embodiments, the graphenic and/or ionic shielding component is configured within the mesoporous carbon interlayer component, or forms a separate layer, such as distal to the electrode substrate (e.g., wherein the mesoporous interlayer component is configured between the electrode substrate and the graphenic and/or ionic shielding layer).

In certain embodiments, an integrated interlayer composition (e.g., comprising (i) at least one interlayer component, and (ii) an electrode substrate and/or separator), the process comprising:
a. providing a fluid stock, the fluid stock comprising a carbonaceous component (e.g., porous carbon, such as mesoporous carbon, and/or a graphenic component, such as graphene oxide or reduced graphene oxide);
b. providing a separator film (e.g., polymer or polymer-ceramic membrane) or a first electrode material (e.g., lithium sulfur cathode, such as comprising mesoporous carbon and sulfur);
c. applying an electrical charge to the fluid stock (e.g., thereby forming a charged fluid stock);
d. injecting the charged fluid stock into a stream of gas (or ejecting the charged fluid stock with a gas stream) (e.g., forming an aerosol or plume);
e. collecting a carbonaceous deposition on the separator material or the first electrode material.

In specific embodiments, the carbonaceous component comprises mesoporous carbon. In certain embodiments, mesoporous carbon is mesoporous carbon nanofiber, such as comprising large mesoporous structures described herein. In other preferred specific embodiments, the carbonaceous component comprises a graphenic component, such as graphene, graphene oxide, reduced graphene oxide, a functionalized graphene, such as described herein, or a combination thereof. In specific embodiments, the graphenic component comprises a functionalized graphene, such as comprising an ionic shielding moiety described herein.

In specific embodiments, a method of preparing a separator-ionic shield composition (e.g., laminate) comprises:
a. providing a fluid stock, the fluid stock comprising a carbonaceous component (e.g., a graphenic component, such as functionalized graphene (e.g., graphene oxide or reduced graphene oxide) comprising one or more polar or ionic group, such as an SOₚR_{q} group described herein (e.g., wherein p=1-4, q=1-3, and R is as described herein);
b. providing a separator film (e.g., polymer or polymer-ceramic membrane);
c. applying an electrical charge to the fluid stock (e.g., thereby forming a charged fluid stock);
d. injecting the charged fluid stock into a stream of gas (e.g., forming an aerosol or plume);
e. collecting a carbonaceous deposition on the separator material (e.g., a surface thereof).

In specific embodiments, sulfur, as referred to herein, includes reference to an electrode active sulfur material (e.g., functions as a positive electrode material in a lithium battery, such as having a specific capacity of at least 100 mAh/g), or a precursor thereof. In more specific embodiments, the sulfur is or comprises elemental sulfur (e.g., Ss), a sulfur allotrope, a sulfide (e.g., a lithium sulfide (e.g., Li₂S, Li₂S₂, Li₂S₃, Li₂S₄, Li₂S₆, Li₂S₈, combinations thereof, and/or disassociated ions thereof)), a polysulfide, or the like. In further or additional embodiments, the polysulfide comprises an organo-polysulfide, such as a polysulfide copolymer. In specific embodiments, the polysulfide is poly(sulfur-random-1,3-diisopropenylbenzene) (poly(S-r-DIB)) and/or a species set forth in WO 2013/023216, which is incorporated herein for such disclosure. In addition, the sulfur of any electrode or electrode material described herein is or comprises any one or more sulfur material as described above. Any suitable solvent is optionally utilized in the fluid stock, such as carbon disulfide (CS₂), alcohol, acetone, chlorobenzene, benzene, toluene, xylene, chloroform, aniline, cyclohexane, dimethyl furan (DMF), or the like.

Also provided in certain embodiments herein are components for manufacturing the electrodes herein, precursors thereof, and the like. For example, in some embodiments, provided herein are fluid stocks described herein. The concentration of additives (e.g., active materials, such as sulfur, mesoporous carbon, graphenic components, and/or conductive additives) are provided in any suitable concentration, such as in ranges from about 1 wt. % to about 50 wt. %, e.g., 1 wt. % to about 25 wt. %. In specific instances, use of a gas assisted process herein facilitates the use of very high concentration stocks and/or high viscosity stocks, with very good throughput and uniformity upon deposition.

In certain embodiments, additives or components described herein are deposited onto a suitable surface using any suitable process. While certain embodiments described herein include electrospin or electrospray techniques, any suitable deposition technique for achieving the thin coatings, layers, depositions, or films described herein is contemplated. In specific embodiments, the process is a spray process, such as air spraying or electrospraying, or spin process, such as gas assisted electrospinning. In preferred embodiments, the processes are electrospray (for films/depositions/layers) and electrospin (for nanofibers) processes controlled and/or assisted by a gas stream. In specific embodiments, the electrospray and/or electrospin process comprises injecting a charged jet or plume of a fluid stock provided herein into a gas stream, or ejecting a jet or plume of a fluid stock from a nozzle in the presence of one or more gas stream. In specific instances, the gas stream serves to facilitate disruption of the jet and/or plume (e.g., in electrospray of facilitating breaking the jet or droplets/particles of the plume into smaller droplet/particles), facilitate greater uniformity of dispersion of the droplets/particles of the plume, and/or facilitate uniform deposition (e.g., of droplets and/or particles of the plume) onto a surface (e.g., of a substrate described herein).

In some embodiments, a material or layer provided herein comprises additive or component, wherein the standard deviation of the concentration of the additive or component in the material or layer is less than 100% (e.g., less than 70%, less than 50%, less than 40%, less than 30%, less than 20%, less than 10%, or the like) of the average concentration (e.g., of a standard measurement, such as a square centimeter). In some instances, uniformity of deposition of component onto the surface facilitates uniform loading of the component, which results, in some instances, in improved quality control from batch to batch, improved performance of the overall cell, and other benefits. In certain instances, uniformity of deposition of component facilitates uniform porosity, pore size, and/or density of a surface, or layer or domain, thereby reducing areas of too much or not enough coverage, which may result in poor cell performance (e.g., because of more/less reactive domains, poor lithium mobility through the domain or layer in domains where too much additive is present and/or poor retention of sulfur when the porosity of the layer or domain is too great to retard the passage of sulfur therethrough, etc.).

As discussed above, in some preferred embodiments, electrospray and electrospin processes facilitated by a gas flow. In specific embodiments, the process comprises providing a pressurized gas (e.g., air, nitrogen, or the like) to a second inlet of a second conduit of a nozzle provided herein (e.g., comprising a first inlet to which the fluid stock is provided). In specific embodiments, the second conduit surrounds (at least partially, or completely) the first conduit and/or the first conduit is positioned inside the second conduit. In some instances, providing the high pressure gas to the second inlet thereby provides high velocity gas at a second outlet of the second conduit. In specific embodiments, the second conduit is enclosed along the length of the conduit by a second wall having an interior surface and the second conduit has a second inlet and a second outlet (as discussed herein). In some embodiments, the second conduit has a second diameter. In certain embodiments, the exterior surface of the first wall and the interior surface of the second wall being separated by a conduit gap, the ratio of the conduit overlap length to the first diameter being about 1 to 100, preferably about 10.

Any suitable velocity of gas is used an any process calling for a stream of gas herein, such as about 1 m/s or more, about 10 m/s or more, about 25 m/s or more, about 50 m/s or more, about 100 m/s or more, about 200 m/s or more, about 300 m/s or more, or the like. Any suitable pressure of gas is optionally utilized, such as suitable to achieve a velocity described herein, such as at least 20 pounds per square inch (psi), at least 30 psi, at least 40 psi, at least 50 psi, at least 100 psi, at least 200 psi, or the like (e.g., at the nozzle; in some instances, higher pressures are provided at the outlet of a tank or pump, but may be reduced when multiple nozzles are utilized from a single source). In certain embodiments, the gas is any suitable gas, such as comprising air, oxygen, nitrogen, argon, hydrogen, or a combination thereof.

In various embodiments, a fluid stock provided herein comprises described components in any suitable concentration. The concentration of additive (e.g., active material additive, such as sulfur or other sulfur component, mesoporous carbon, graphenic component, conductive additive, and/or the like), individually or in combination, is up to about 80 wt. %, up to about 70 wt. %, about 1 wt. % to about 50 wt. %, about 5 wt. % to about 40 wt. %, about 10 wt. % to about 25 wt. %, or the like. In the case of polymers, if electrospray is utilized, concentrations are generally kept low enough to keep inhibit the formation of fibers.

In specific embodiments, carbon inclusions include, by way of non-limiting example, graphene, functionalized graphene, graphene oxide, reduced graphene oxide, carbon nanotubes, graphene nanoribbons, carbon nanofibers, mesoporous carbon, and/or any combination thereof. In general, carbon or carbonaceous or graphenic components (e.g., in an additive or substrate herein) described herein comprise at least 60 wt. % (on an elemental basis) carbon, such as about 60 wt. % to about 100 wt. % carbon, about 70 wt. % or more, about 80 wt. % or more, about 90 wt. % or more, about 95 wt. % or more, or the like. In various embodiments, the remainder of the elemental mass includes any suitable element(s), such as hydrogen, oxygen, nitrogen, halide, sulfur, or the like, or combinations thereof.

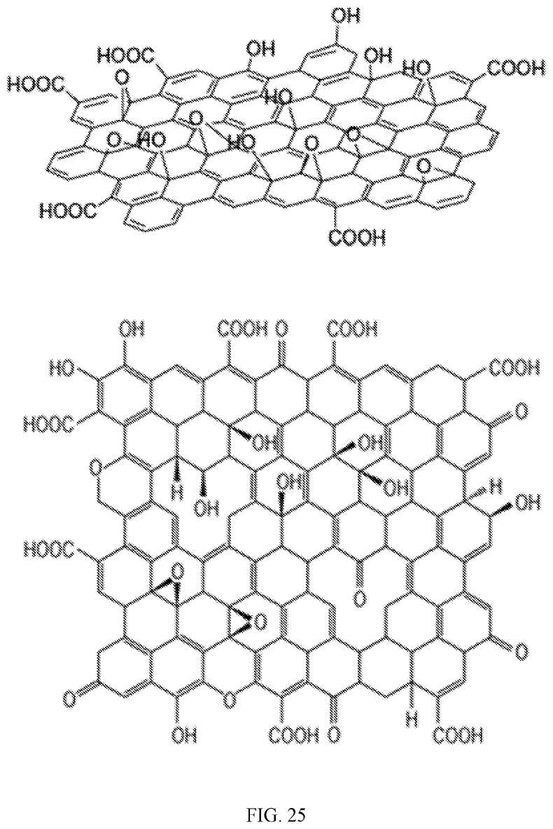

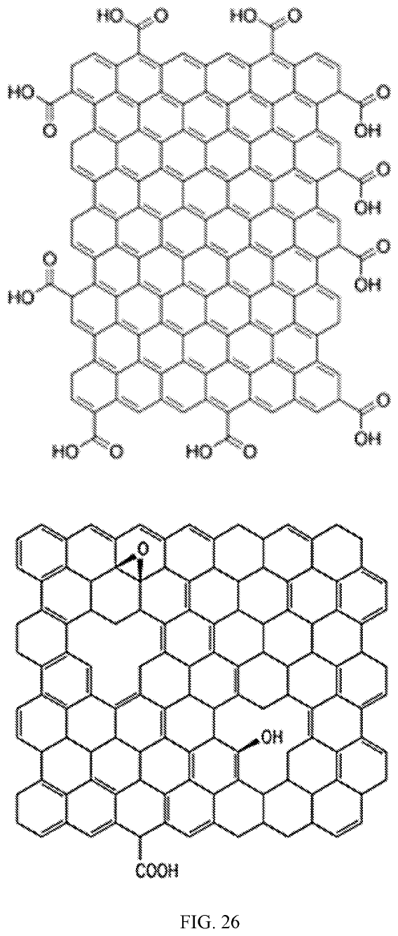

In specific embodiments, the carbon inclusion material is a graphenic component, e.g., functionalized graphene, such as graphene that has one or more carbon atom thereof substituted with one or more additional atom, such as oxygen, halide, hydrogen, sulfur or sulfur containing radicals (e.g., thiols, alkylthio groups, etc.), nitrogen or nitrogen containing radicals (e.g., amine, nitro, etc.), and/or the like. Generally, graphene or graphenic components herein have a general two-dimensional structure (e.g., with 1-25 layers), with a honey-comb lattice structure (which in some instances, such as in non-pristine graphene, graphene oxide, reduced graphene oxide, or the like, comprises certain defects therein, such as described and illustrated herein). In specific embodiments, the graphenic component is an oxidized graphene component. In some instances, the carbon material is or comprises a graphenic component, such as graphene, graphene oxide, reduced graphene oxide, or a combination thereof. In specific embodiments, the oxidized graphene component is a graphene component functionalized with oxygen, such as with carbonyl (C═O) groups, carboxyl groups (e.g., carboxylic acid groups, carboxylate groups, COOR groups, such as wherein R is a C1-C6 alkyl, or the like), —OH groups, epoxide groups, ether (—O—) groups, and/or the like. FIG. 25 illustrates an exemplary oxidized graphene component (graphene oxide) structure including COOH, OH, epoxide, ether, and carbonyl groups. Other graphene oxide structures are also contemplated herein. In certain embodiments, the oxidized graphene component (e.g., graphene oxide) comprises about 60% or more carbon (e.g., 60% to 99%). In more specific embodiments, the oxidized graphene component (e.g., graphene oxide) comprises about 60 wt. % to about 90 wt. % carbon, or about 60 wt. % to about 80 wt. % carbon. In further or alternative specific embodiments, the oxidized graphene (e.g., graphene oxide) component comprises about 40 wt. % oxygen or less, such as about 1 wt. % oxygen to about 40 wt. % oxygen, about 10 wt. % oxygen to about 40 wt. % oxygen, about 35 wt. % oxygen or less, about 1 wt. % to 35 wt. % oxygen, or the like. In some preferred embodiments, the oxidized graphene component comprises sufficient oxygen so as to facilitate dispersion and opening of the graphene sheets in an aqueous medium. In some embodiments, the total percentage of carbon and oxygen does not constitute 100% of the graphene component or analog, with the additional mass comprising any suitable atoms, such as hydrogen, nitrogen (e.g., in the form of amine, alkyl amine, and/or the like), sulfur (e.g., in the form of a thiol, thioether, sulfoxide, sulfone, sulfonate, or the like), halide (e.g., fluoride), and/or the like, or any combination thereof. In specific instances, a functionalized graphenic component described herein comprises one or more ionic shielding group (e.g., negatively charged, acidic or Lewis acidic) group(s), such as comprising a nitrogen, sulfur (e.g., in the form of a sulfoxide, sulfone, sulfonate, or the like), and/or the like. In addition, graphene components utilized in the processes and materials utilized herein optionally comprise pristine graphene sheets, or defective graphene sheets, such as wherein one or more internal and/or external rings are oxidized and/or opened, etc. FIG. 26 illustrates various exemplary reduced graphene oxide (rGO) structures. As illustrated, the structure may have a basic two dimensional honeycomb lattice structure of graphene, with (or without) defects and with (or without) other atoms present (e.g., hydrogen and/or oxygen, including, e.g., oxidized structures, such as discussed and illustrated herein). In various embodiments, the graphenic component (e.g., reduced graphene oxide (rGO)) comprises about 60% or more carbon (e.g., 60% to 99%), such as about 70 wt. % or greater, about 75 wt. % or more, about 80 wt. % or greater, about 85 wt. % or greater, about 90 wt. % or greater, or about 95 wt. % or greater (e.g., up to about 99 wt. % or more). In certain embodiments, the graphenic component (e.g., rGO) comprises about 35 wt. % or less (e.g., 0.1 wt. % to 35 wt. %) oxygen, e.g., about 25 wt. % or less (e.g., 0.1 wt. % to 25 wt. %) oxygen, or about, about 20 wt. % or less, about 15 wt. % or less, about 10 wt. % or less (e.g., down to about 0.01 wt. %, down to about 0.1 wt. %, down to about 1 wt. % or the like) oxygen. In specific embodiments, the graphenic component (e.g., rGO) comprises about 0.1 wt. % to about 10 wt. % oxygen, e.g., about 4 wt. % to about 9 wt. %, about 5 wt, % to about 8 wt, %, or the like. In some embodiments, the total percentage of carbon and oxygen does not constitute 100% of the reduced graphene component, with the additional mass comprising any suitable atoms, such as hydrogen, or other atoms or components as discussed herein.

In certain embodiments, any suitable nozzle system configuration is acceptable. In specific embodiments, the first (inner conduit) diameter is about 0.1 mm or more (e.g., about 0.1 mm to about 10 mm for smaller nozzle configurations, such as using direct voltage (V_{DC})), about 0.5 mm or more, about 1 mm or more, about 5 mm or more, about 7.5 mm or more, about 10 mm or more, (e.g., up to about 2.5 cm, up to about 3 cm, up to about 5 cm, or the like) (such as when using larger configurations, e.g., when using alternating voltage (V_{AC})). In further or alternative embodiments, the second (outer conduit) diameter is any suitable diameter that is larger than the first diameter (e.g., about 1.1 times or more the first diameter, about 1.5 times or more the first diameter, about 1.1 times to about 3 times, or about 1.1 times to about 2 times the first diameter). In specific embodiments, the second diameter is about 5 mm to about 10 cm (e.g., about 10 mm to about 8 cm, or about 0.2 mm to about 15 mm, such as for smaller nozzle configurations).

In certain embodiments, the conduit gap (the average distance between the exterior surface of the inner conduit wall and the interior surface of the outer conduit wall) is any suitable distance, such as a distance configured to allow suitable airflow quantity and/or velocity to the nozzle tip and beyond to break up and/or otherwise facilitate reducing the size of the droplets produced by the spraying process and/or system. In specific embodiments, the conduit gap is about 0.1 mm or more, about 0.5 mm or more, about 1 mm or more, about 5 mm or more, about 10 mm or more, or the like (e.g, up to about 20 mm or up to about 30 mm).

In certain embodiments, the spraying process and/or system provided herein comprises applying and/or is configured to provide any suitable voltage to the nozzle. In some instances, the voltage is about 8 kV or more, e.g., about 8 kV_{DC} to about 30 kV_{DC}, about 10 kV_{DC} to about 25 kV_{DC}, about 18 kV_{AC} to about 25 kV_{AC}, or about 30 kV_{AC} or more (e.g., with higher voltages used, in some instances, with systems comprising large numbers of nozzles). In certain embodiments, a power supply is configured to provide a voltage (e.g., a direct voltage (V_{DC}) or an alternating voltage (V_{AC}) to the nozzle. In some instances, higher voltage are optionally utilized when a voltage is applied to nozzle system comprising a number of nozzles. In some embodiments, if appropriate, a voltage is optionally not applied to a system and/or process provided herein. In some embodiments, the power supply system comprises any suitable components to provide the desired voltage, power, frequency, wave shape, etc. to the nozzle. In specific embodiments, the power supply comprises, by way of non-limiting example, a generator, an amplifier, a transformer, or a combination thereof. In certain embodiments, the voltage (V_{AC}) is applied at any frequency, e.g., 50 Hz or more, about 50 Hz to about 500 Hz, about 60 Hz to about 400 Hz, about 60 Hz to about 120 Hz, about 250 Hz, or the like.

In certain embodiments, processes and/or systems provided herein are configured to facilitate very high flow and throughput rates (e.g., relative to other systems, such as direct current systems, including, in some instances, e.g., gas-controlled, direct current systems). In specific embodiments, the flow rate of the fluid stock (e.g., provided to the first inlet of the nozzle) is about 0.01 mL/min or more, such as about 0.1 mL/min or more (e.g., about 0.1 mL/min to about 20 mL/min, about 0.3 mL/min or more, about 0.5 mL/min or more, about 1 mL/min or more, about 2.5 mL/min or more, about 5 mL/min or more, or the like). In certain embodiments, processes and/or systems provided herein allow the processing of highly viscous fluids (e.g., relative to other spray systems). For example, in some embodiments, the viscosity of a fluid stock provided herein is about 1 cP or more, about 5 cP or more, about 10 cP or more, about 20 cP or more, about 100 cP or more, about 250 cP or more, about 500 cP or more, and/or up to 10 Poise or more.

In certain embodiments, provided herein is a process for producing a deposition (e.g., a thin layer deposition), the process comprising coaxially electrospraying or electrospinning a fluid stock with a voltage and a gas, thereby forming a jet and/or a plume, the gas at least partially surrounding the jet and/or the plume (e.g., the plume comprising a plurality of droplets, such as nanoscale droplets described herein). In some instances, the fluid stock, the jet, and/or the plume comprise a liquid medium (e.g., solvent) and an additive (e.g., sulfur and/or a conducting additive).

In certain embodiments, processes and systems described herein allow for good control of the thickness of depositions (e.g., additive loading on (e.g., the surface of) a substrate described herein) provided for and described herein. In some embodiments, a deposition provided herein is a thin layer deposition, e.g., having an average thickness of 1 mm or less, e.g., about 1 micron to about 1 mm. In specific embodiments, the deposition has a thickness of about 500 micron or less, e.g., about 1 micron to about 500 micron, about 1 micron to about 250 micron, or about 10 micron to about 200 micron. Further, the processes and systems described herein not only allow for the manufacture of thin layer depositions, but of highly uniform thin layer depositions. In some embodiments, the depositions provided herein have an average thickness, wherein the thickness variation is less than 50% of the average thickness, e.g., less than 30% of the average thickness, or less than 20% of the average thickness.

In certain embodiments, provided herein are materials, compositions, electrodes and processes for preparing such materials, compositions and electrodes with uniform sulfur and/or additive loading therein and/or thereon. In certain embodiments, the variation of loading of sulfur and/or additive in and/or on an electrode substrate or an overall electrode system (e.g., comprising both electrode substrate and interlayer component(s)) herein is less than 50% based on weight, such as less than 30%, less than 20%, or the like. In various embodiments, the sulfur loading of (in and/or on) a electrode substrate or an overall electrode system (e.g., comprising both electrode substrate and interlayer component(s)) herein is about 3 mg/cm² or more, about 4 mg/cm² or more, about 5 mg/cm² or more, or more, such as described herein. In certain embodiments, additive (e.g., conducting additive and/or graphenic component, such as an oxidized graphenic component (e.g., graphene oxide or reduced graphene oxide)) loading on the surface of a substrate herein is at least 0.01 mg/cm², such as about 0.05 mg/cm² to about 2 mg/cm², such as about 0.1 mg/cm² to about 1 mg/cm². In specific instances, loading of graphenic and conducting additive (e.g., carbon black) is utilized, such as in and/or on the surface of the substrate in any suitable amount.

Further, in some embodiments, it is desirable that any additives in the fluid stock are dissolved and/or well dispersed prior to electrospray, e.g., in order to minimize clogging of the electrospray nozzle, ensure good uniformity of dispersion of any inclusions in the resulting deposition, and/or the like. In specific embodiments, the fluid stock is agitated prior to being provided to the nozzle (e.g., inner conduit inlet thereof), or the system is configured to agitate a fluid stock prior to being provided to the nozzle (e.g., by providing a mechanical stirrer or sonication system associated with a fluid stock reservoir, e.g., which is fluidly connected to the inlet of the inner conduit of an electrospray nozzle provided herein).

Further iterations and details for electrospray processes, as well as deposition characteristics, optionally utilized in certain embodiments herein are set forth in U.S. Provisional Patent Application Nos. PCT/US16/61235, entitled “Air Controlled Electrospray Manufacturing and Products thereof,” filed Nov. 10, 2016 and PCT/US16/61238, entitled “Alternating Current Electrospray Manufacturing and Products thereof,” both filed Nov. 10, 2016, and both of which are incorporated herein by reference for such disclosure.

### EXAMPLES

### Example 1. Mesoporous Carbon Nanofibers

A fluid stock is prepared by dissolving CDA (from Sigma Aldrich: Mn=50,000; degree of substitution=2.4 or 39.7 wt % acetyl) and PAN (from PolyScience, Inc.: Mw=150,000) in dimethylformamide at a PAN:CDA weight ratio of 1:1 and a concentration of 13 wt. % polymer.

The fluid stock is electrospun (e.g., using a flow rate of 0.02 mL/min) in a center tube (20 gauge), with a concentric outer tube providing gas for gas-assisted electrospinning. A voltage (e.g., of about 10-20 kV) is applied (e.g., with a tip to collector distance of about 10-20 cm). Nanofibers comprising a combination of PAN and CDA are collected. Humidity of the chamber into which the fluid stock is electrospun is controlled, with the process being repeated at humidities of 10% RH, 30% RH, and 50% RH. Nanofibers are collected and thermally annealed at 270 C (heated to 270 C at 1 C/min) for 0.5-3 hours and thermally carbonized at 1000 C (heated to 1000 C from 270 C at 10 C/min) under nitrogen for 15-60 minutes.

Using such a process, carbonized nanofibers comprise a mesoporous carbon matrix are prepared. TEM images of the cross and longitudinal sections of the microtomed carbonized and activated nanofibers are shown in FIG. 11. As illustrated, mesopores are irregular. The interconnectivity of the pores seems to increase with increasing pore size. Pores also appear to be aligned with the axis of the nanofiber and that few pores lead to the surface, especially for 10% RH. The TEM images of the PAN only fibers also show no mesopores like the BJH analysis did. FIG. 11 (a) illustrates a TEM image of a cross-section of a mesoporous carbon nanofiber prepared using 10% RH, (b) illustrates a TEM image of a longitudinal-section of a mesoporous carbon nanofiber prepared using 10% RH, (c) illustrates a TEM image of a cross-section of a mesoporous carbon nanofiber prepared using 30% RH, (d) illustrates a TEM image of a longitudinal-section of a mesoporous carbon nanofiber prepared using 30% RH, (e) illustrates a TEM image of a cross-section of a mesoporous carbon nanofiber prepared using 50% RH, (f) illustrates a TEM image of a longitudinal-section of a mesoporous carbon nanofiber prepared using 50% RH. As illustrated in the TEM image, the nanofiber comprises a highly porous structure.

Moreover, FIG. 9 and FIG. 10 illustrate incremental pore area and incremental pore volumes as a function of pore size of the resultant fibers. As is demonstrated, larger mesopore sizes are observed in samples wherein higher humidities are utilized during manufacturing.

For example, electrospinning and thermal treatment of PAN/CDA at 10% RH produced mesoporous carbon having a (BET) surface area of 680 m²/g (74% micropore), with a mesopores of greater than 10 nm providing the greatest contribution to mesoporous surface area 901 and mesoporous volume 1001. Electrospinning and thermal treatment of PAN/CDA at 30% RH produced mesoporous carbon having a (BET) surface area of 653 m²/g (77% micropore), with a mesopores of over 20 nm providing the greatest contribution to mesoporous surface area 902 and mesoporous volume 1002. Electrospinning and thermal treatment of PAN/CDA at 50% RH produced mesoporous carbon having a (BET) surface area of 660 m²/g (81% micropore), with a mesopores of over 30 nm providing the greatest contribution to mesoporous surface area 903 and mesoporous volume 1003. By contrast, electrospinning and thermal treatment of PAN at 30% RH produced mesoporous carbon having a (BET) surface area of 650 m²/g (85% micropore), with very little contribution to the surface area made by mesoporous structures 904 and mesoporous volume 1004.

As illustrated, mesoporous carbon nanofiber mats with large mesopores (e.g., >50 nm) are prepared based on a blend template. Other work on lithium sulfur cathodes use other carbon having various morphologies and pore distributions but tend to rely on a time consuming, hard templating process with silica or a soft templating process that mainly produces thin films with expensive block copolymers or toxic precursors which limits the commercial viability of these carbons. With the processes provided herein, mesopores are templated by the phase separation of two immiscible polymers, such as exemplified polyacrylonitrile (PAN) and cellulose diacetate (CDA). After mixing, the solution is electrospun into nanofibers where microphase separation occurs. The rapid solvent evaporation during electrospinning and the physical constraints of being stretched into a nanofiber freezes the phase separation into meso-scaled domains within the fiber. With heat treatment and carbonization, the PAN component of the fiber is converted to carbon while the sacrificial CDA component is pryolyzed leaving behind a pore. Further, as illustrated, by changing the humidity during the electrospinning process, the average size of the mesopore was adjusted between 17 and 50+ nm. In addition, further examples discuss the study of the effect of meso/microporosity on cell performance, where we find that large mesopores (>15 nm) contribute substantially to the rate capability of the battery without loss to capacity retention compared to smaller mesopores.

### Example 2. Non-Mesoporous Carbon Nanofibers

Using a process similar to that described in Example 1, carbon fibers are prepared using PAN only (i.e., no sacrificial polymer, such as CDA) is included. FIG. 11 (g) illustrates a TEM image of a cross-section of a carbon nanofiber prepared using 30% RH, and (h) illustrates a TEM image of a longitudinal-section of a carbon nanofiber prepared using 30% RH. As is observed, the mesoporous structures of the nanofibers of Example 1 are missing. Moreover, as illustrated in FIG. 9 and FIG. 10, the material is not mesoporous and has a lower surface area than the mesoporous carbon prepared according to Example 1.

### Example 3. Mesoporous Carbon Fiber Electrode Substrate

A mesoporous carbon nanofiber mat is utilized as a cathode substrate to facilitate easy access and release of lithium polysulfides through micro and meso pores especially at high rates. First, we deposit conductive carbon and sulfur into the mesoporous carbon nanofiber substrate via AC electrospray. The controlled dispersion of conductive carbon and high loading of sulfur into meso and micro pores in the substrate offer high capacity with great retention at high rates. The schematic of the facile fabrication of highly loaded sulfur cathode via AC electrospraying the mixture of sulfur and conductive carbon in CS₂ solution on to mesoporous carbon nanofiber substrate is illustrated in FIG. 12.

For the AC electrospray process, a fluid stock comprising sulfur and conductive carbon inclusions in carbon sulfide (CS₂) is prepared. The fluid stock is homogenized using stirring and sonication. The fluid stock is electrosprayed by injecting the fluid stock into a gas (air) stream, such as using an inner conduit/outer conduit configuration described herein. A voltage of about 10 kV to about 15 kV is maintained at the nozzle. A deposition is collected on a porous carbon substrate (e.g., having a coarse porous layer and a dense porous layer), positioned about 20 cm to about 25 cm from the nozzle. The fluid stock is electrosprayed until desired sulfur component is loaded onto the substrate. Using processes such as described, electrodes are prepared and manufactured into lithium sulfur battery cells (e.g., using a stretched polyolefin separator (Celgard), and a lithium foil counter electrode (anode) (e.g., with a metal foil current collector)).

The results of Li—S coin cell tests with Li metal anode and cathode with high loading of sulfur (5.0 mg/cm²) at relatively high rate (0.5 C) are shown in FIG. 13 (number labels referring to cycle number) and FIG. 14. As illustrated, despite such a high sulfur loading, Li—S batteries exhibit the high capacity, above 1,000 mAh/g for 100 cycles and high Coulombic efficiency. In FIG. 15, the rate capability of Li—S batteries with 3.5 mg/cm² sulfur loading is also shown, demonstrating that the capacity at 2 C is still above 800 mAh/g which is two thirds of the capacity at 0.5 C.

### Example 4. Coated Cathode Manufacturing

In some instances, a cathode substrate material can comprise a discrete nanofiber mat, such as provided in Example 3. In other instances, a film material can be manufactured by electrospraying mesoporous carbon (e.g., nanofibers and/or particles/powder), such as onto a current collector. In one instances, the mesoporous carbon is electrosprayed onto a substrate to form a film, and the sulfur component is subsequently infused into the substrate, such as by an electrospray technique provided herein. In one instances, a carbon additive is included in the electrospraying of the mesoporous carbon. In another instance, the carbon additive is infused into the substrate concurrently with the sulfur component. In another instance, an electrode component is manufactured in a one pot process wherein, a fluid stock comprising mesoporous carbon and a sulfur component is electrosprayed onto a current collector to form an electrode substrate film pre-infused with sulfur component.

For the electrospray process, a fluid stock comprising mesoporous carbon and/or sulfur component is prepared. The fluid stock is homogenized using stirring and sonication. The fluid stock is electrosprayed by injecting the fluid stock into a gas (air) stream, such as using an inner conduit/outer conduit configuration described herein. A voltage of about 10 kV to about 15 kV is maintained at the nozzle. A deposition is collected on a metal foil current collector positioned about 20 cm to about 25 cm from the nozzle. The fluid stock is electrosprayed until desired film thickness is loaded onto the substrate. Using processes such as described, electrodes are prepared and manufactured into lithium sulfur battery cells (e.g., using a stretched polyolefin separator (Celgard), and a lithium foil counter electrode (anode) (e.g., with a metal foil current collector)).

### Example 5. Discrete Mesoporous Carbon Interlayer

A lithium sulfur coin cell is assembled using a conventional carbon cathode comprising conductive carbon (carbon black, Super P) and is highly loaded with sulfur (70%). The cathode is configured together with, a polyolefin separator and a lithium anode into the coin cell. Cells are assembled with and without a discrete interlayer comprising mesoporous carbon nanofiber. As illustrated in FIG. 2, the cell is cycled for about 100 cycles with an initial specific capacity of about 1,000 mAh/g and exhibits a very good capacity retention.

### Example 6. Discrete Mesoporous Carbon Interlayers

A lithium sulfur coin cell is assembled using a conventional carbon cathode comprising conductive carbon (carbon black, Super P) and is highly loaded with sulfur (70%). The cathode is configured together with, a polyolefin separator and a lithium anode into the coin cell. Cells are assembled with a discrete interlayer comprising mesoporous carbon nanofiber.

A number of cells are prepared comprising a variety of different mesoporous nanofiber materials. Mesorporous carbon nanofibers prepared according to Example 1 are configured into the cells described. Specifically, mesoporous carbon nanofibers prepared from pyrolyzed blend polymers electrospun at 10% RH, 30% RH, and 50% RH are utilized. As discussed above, these differing conditions correspond to increasing mesopore size, with increasing relative humidity. Prior to incorporating into the interlayer, the mesoporous carbon in activated (e.g., to create additional microporous structures and/or make more internal mesoporous structures accessible). For comparison, a cell is also prepared using activated (microporous) carbon nanofibers prepared from pyrolyzed PAN. As illustrated in FIG. 22, the mesoporous carbon nanofibers with larger mesoporous (30% RH and 50% RH) (top two lines) exhibit much better initial capacity and capacity retention relative to the mesoporous carbon nanofibers with the smaller mesoporous (10% RH) (middle line), which in turn exhibits better initial capacity than the carbon nanofibers comprising activated non-mesoporous carbon nanofibers (second to bottom line).

In addition, a cell is prepared using mesoporous carbon (10% RH) that has not been activated (e.g., having low microporous content and/or access to internal mesoporous structures). As illustrated in FIG. 22, the non-activated mesoporous carbon nanofibers exhibited good initial specific capacity (in line with the best mesoporous structures) (rate of C/2), but the capacity rapidly fades until the capacity is the worst of all examples (bottom line).

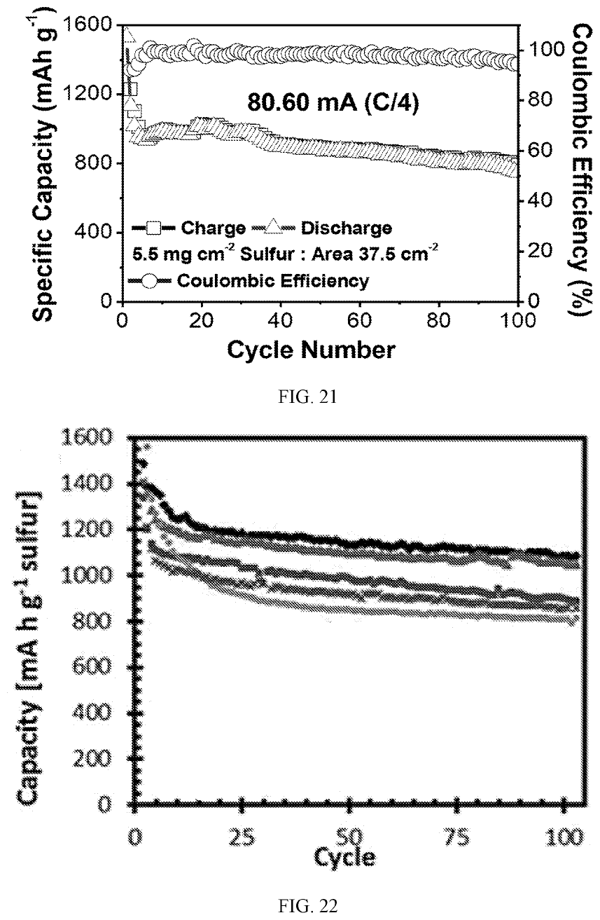

Similar cells are prepared using 6.2 mg_{sulfur}/cm² (with 2.5 wt. % mesoporous carbon particles (KB) vs. sulfur) on a mesoporous carbon nanofiber substrate (5.5 mg) with two mesoporous carbon nanofiber interlayer components (10 mg). As illustrated in FIG. 20, the areal capacity of the cell is well above the targeted 4 mAh/cm² for EVs. Similar cells are prepared with a loading of 5.5 mg sulfur per cm² cathode, and demonstrate good capacity retention, as well as good Coulombic efficiencies, as illustrated in FIG. 21.

### Example 7. Discrete Mesoporous Carbon Interlayer—Rate Capability

Cells similar to those in Example 6 are prepared. These cells are tested for their charge rate capabilities. Typically, lithium sulfur cells, particularly those with high sulfur loading have extremely low rate capabilities, such as C/5, meaning that such cells take 5 hours to charge upon depletion. For many commercial applications, such charge rates are too slow.

As illustrated in FIG. 16, the cells comprising the carbon nanofibers exhibited very good rate capabilities, with high charge rates giving good capacities, with the interlayers comprising mesoporous carbon nanofibers with the largest mesopores exhibited the best rate capabilities. As illustrated in FIG. 8, in some instances, larger pores can allow better access to sulfur deposited within the pores during cycling.

### Example 8. Mesoporous Carbon Substrate and Interlayer

Assembling a cell using a mesoporous carbon nanofiber electrode substrate material similar to as described in Example 2 and a mesoporous carbon nanofiber interlayer component as described in Examples 6 and 7, a lithium sulfur cell is prepared using a mesoporous carbon nanofiber electrode substrate and an interlayer comprising a mesoporous carbon nanofiber interlayer component. The sulfur is initially loaded into the carbon substrate at 5 mg/m², with no sulfur initially loaded into the interlayer. As illustrated in FIG. 1, a very good capacity is achieved, with good capacity retention, even at a rate of C/2 and very high sulfur loading.

### Example 9. Graphenic Component

Cathodes are prepared loading 4 mg/cm² sulfur (with mesoporous carbon particles (KB) (2.5%)) onto a porous carbon substrate (BC carbon paper substrate). Cathode systems are further prepared with and without a graphenic oxide component on the surface of the carbon substrate. Full cells are prepared as described herein. As is illustrated in FIG. 3, the presence of the graphenic additive (0.5 mg GO) 301 between the cathode substrate and the interlayer improved capacity of the cell by about 200 mAh/g or more (at 0.5 C), relative to the system lacking a graphenic additive 302.

### Example 10. Discrete Interlayer with and without Graphenic Component

The synergy between mesoporous carbon (MC) and reduced graphene oxide (RGO) interlayer components is tested. Two Li—S cell configurations with high loading of sulfur (5 mg/cm²) are tested, having the configuration illustrated in FIG. 5. Generally, as shown in FIG. 5, the first Li—S cell has of a carbon paper cathode with a mesoporous carbon nanofiber (MPCNF) interlayer, while the second Li—S cell has a RGO coated MPCNF interlayer.

Such configurations are made using a carbon paper electrode substrate (demonstrating the effect of the mesoporous interlayer without the benefit of a mesoporous electrode substrate), which is loaded with sulfur and carbon additive (KB). The sulfur and carbon additive are infused into the substrate using an electrospray technique similar to that described in Example 3. Regarding the interlayer, in a first cell configuration, a discrete mesoporous carbon nanofiber mat is configured between the electrode substrate and separator. In another configuration, a discrete mesoporous carbon nanofiber mat is coated on one side using a gas assisted electrospray process, such as similar to the one described for depositing sulfur and additive on the electrode substrate in Example 3 before positioning the interlayer between the electrode substrate and the separator.

As illustrated in FIG. 6, it is observed that when a thin layer of RGO is coated on the MPCNF interlayer, the capacity retention of the cell is drastically improved. This suggests great synergy between mesoporous carbon and reduced graphene oxide in interlayer applications.

Similar cells are prepared using a graphene oxide interlayer component as well. Cells are prepared loading 4 mg/cm² sulfur (with mesoporous carbon particles (KB)) onto a carbon substrate. In a first cell, graphene oxide is loaded onto the substrate and one porous carbon interlayer component is configured between the carbon substrate and the separator. In a second cell, the porous carbon interlayer component is provided without the graphene oxide. And, in a third cell, no graphene oxide is utilized, but three porous carbon interlayer components are utilized. As can be seen in FIG. 4, the cell with the graphene oxide component and the porous carbon interlayer 301 component provide good capacity, with good capacity retention. The next best performance is observed in the cell comprising one interlayer, with no graphene oxide 302. And, the worst performance is observed in the cell comprising three porous carbon interlayer components 303. This illustrates that the additional carbon component is not the critical element in the configuration because the cell with three layers of porous carbon interlayer component performs the worst, but the combination of the graphenic component and the porous carbon interlayer component.

### Example 11. Integrated Interlayer-Separator

In some instances, an interlayer component can comprise a discrete nanofiber mat, such as provided in Example 5. In other instances, a film material can be manufactured by electrospraying mesoporous carbon (e.g., nanofibers and/or particles/powder), such as onto a current collector.

In one instances, the mesoporous carbon is electrosprayed onto the separator to form a coated separator or an interlayer-separator laminate. In another instance, the mesoporous carbon is combined with a graphenic component (rGO, GO, and/or functionalized graphene) and electrosprayed onto the separator to form an interlayer-separator laminate. In other instances, the graphene component is sprayed onto the separator prior to electrospraying the mesoporous carbon, or sprayed onto the already deposited mesoporous carbon.

For the electrospray process, a fluid stock comprising mesoporous carbon and/or graphenic component is prepared. The fluid stock is homogenized using stirring and sonication. The fluid stock is electrosprayed by injecting the fluid stock into a gas (air) stream, such as using an inner conduit/outer conduit configuration described herein. A voltage of about 10 kV to about 15 kV is maintained at the nozzle. A deposition is collected on a separator film (polymer or polymer-ceramic hybrid) positioned about 20 cm to about 25 cm from the nozzle. The fluid stock is electrosprayed until desired film thickness or mass is loaded onto the separator. Using processes such as described, interlayer-separator laminates are prepared and manufactured into lithium sulfur battery cells.

In this work, compact assemblies can be provided while, at the same time, providing the synergistic interlayer benefits of mesoporous carbon and graphenic components.

### Example 12. Separator Laminate—Ionic Shield

To improve the captivity of soluble polysulfides in the cathode side, we utilize an ionic shield in the cathode system. Three porous separator film materials are provided opposite a gas assisted electrospray nozzle, where each of the following fluid stocks are individually deposited onto one of the films.

Fluid stocks comprising (a) a graphenic component, (b) a mixture of PEDOT and PSS, and (c) PEDOT:PSS and a graphenic component are prepared. The fluid stocks are homogenized using stirring and sonication. Each fluid stock is electrosprayed by injecting the fluid stock into a gas (air) stream, such as using an inner conduit/outer conduit configuration described herein. A voltage of about 10 kV to about 15 kV is maintained at the nozzle. Each deposition is collected on one of the three separator films positioned about 20 cm to about 25 cm from the nozzle. The fluid stock is electrosprayed until desired film thickness or mass is loaded onto the separator. Using processes such as described, separator laminates are prepared and manufactured into lithium sulfur battery cells.

A schematic of ionic shield on the on separator for polysulfides based on coating sulfonated graphene oxide liquid crystal or self-assembled multifunctional hybrids is depicted in FIG. 24. In some instances, functional groups such as sulfone offer repulsive interaction against polysulfides, leading to more effective confinement of polysulfides in the cathode side. The schematic of fabricating sulfonated graphene oxide is also shown. In some instances, polymer (such as PEDOT:PSS) offers conductivity and binding to the separator when GO/PEDOT:PSS solution is coated on the separator via AC electrospray.

1. A lithium battery comprising a first electrode, a second electrode, a separator and an interlayer,
wherein the interlayer comprises a porous and/or mesoporous film or membrane and wherein the interlayer is positioned between the first electrode and the separator; and
wherein the separator is positioned between the interlayer and the second electrode.

2. The battery of claim 1, wherein the interlayer comprises a porous carbon material or a graphenic material selected from the group consisting of graphene, functionalized graphene, graphene oxide, reduced graphene oxide, functionalized graphene oxide, graphene nanoribbons, or the like, or combinations thereof.

3. (canceled)

4. The battery of claim 1, wherein the interlayer is discrete from the separator and first electrode, or the interlayer is discrete from the first electrode.

5. (canceled)

6. The battery of claim 2, wherein the porous carbon material comprises mesoporous carbon or a nanofiber mat comprising one or more mesoporous carbon nanofibers.

7. (canceled)

8. (canceled)

9. The battery of claim 1, wherein the first electrode comprises a porous carbon substrate, a mesoporous carbon substrate, or a graphenic component.

10. (canceled)

11. (canceled)

12. (canceled)

13. (canceled)

14. The battery of claim 1, wherein the first electrode comprises a first domain and a second domain, the first domain comprising a porous carbon substrate and the second domain comprising a graphenic component, and wherein the second domain is proximate to the interlayer.

15. The battery of claim 1, wherein a mass or thickness of the interlayer is at least 20% of a mass or thickness of the first electrode.

16. (canceled)

17. (canceled)

18. The battery of claim 6, wherein the mesoporous carbon nanofiber comprises a plurality of mesopores, the plurality of mesopores having an average dimension of about 20 nm or more.

19. (canceled)

20. The battery of claim 6, wherein a surface area of the one or more mesoporous carbon nanofibers is about 400 m²/g or more and/or wherein the micropore fraction of the surface area is less than 85%.

21. (canceled)

22. (canceled)

23. The battery of claim 1, wherein the first electrode comprises a carbon component and a sulfur component, wherein the sulfur component comprises sulfur, sulfide, polysulfide, organosulfide, or a combination thereof.

24. (canceled)

25. (canceled)

26. The battery of claim 1, wherein the first electrode comprises about 3 mg sulfur component or more per cm² of electrode.

27. (canceled)

28. (canceled)

29. (canceled)

30. (canceled)

31. (canceled)

32. (canceled)

33. (canceled)

34. (canceled)

35. (canceled)

36. (canceled)

37. A process of preparing a battery electrode system, or material thereof, the process comprising:
a. mixing a first polymer with a second polymer, forming a liquid polymer mixture;
b. applying a electrical charge to the liquid polymer mixture, forming a charged liquid polymer mixture;
c. injecting the charged liquid polymer mixture into a stream of gas;
d. thermally carbonizing the first polymer and pyrolyzing the second polymer, forming one or more mesoporous carbon nanofibers; and
e. assembling the one or more mesoporous carbon nanofibers into a battery interlayer.

38. The process of claim 37, wherein the first and second polymers are immiscible.

39. (canceled)

40. The process of claim 37, wherein the first polymer and second polymer are further mixed with a solvent, and the liquid polymer mixture is a liquid polymer solution, and wherein the charged liquid polymer is injected into the gas stream at a direction that is within about 15 degrees of the direction of the gas stream.

41. (canceled)

42. The process of claim 37, wherein stream of gas and/or the ambient atmosphere into which the stream of gas is flowing has a relative humidity (RH) of at least 10%.

43. (canceled)

44. The process of claim 37, wherein the one or more mesoporous carbon nanofibers are activated prior to being assembled into the battery interlayer.

45. (canceled)

46. A process of preparing a battery comprising the steps of claim 44, and further comprising assembling the battery interlayer with a first and second electrode into a battery.

47. (canceled)

48. (canceled)

49. (canceled)

50. A process of preparing a mesoporous carbon nanofiber comprising:
a. mixing a first polymer with a second polymer, forming a liquid polymer mixture;
b. applying a electrical charge to the liquid polymer mixture, forming a charged liquid polymer mixture;
c. injecting the charged liquid polymer mixture into a stream of gas; and
d. thermally carbonizing the first polymer and removing the second polymer, forming one or more mesoporous carbon nanofiber.

51. The process of claim 50, wherein stream of gas and/or the ambient atmosphere into which the stream of gas is flowing has a relative humidity (RH) of at least 10%.

52. The process of claim 50, wherein stream of gas and/or the ambient atmosphere into which the stream of gas is flowing has a relative humidity (RH) of about 30% or more.

53. (canceled)
